(19) United States
(12) Patent Application Publication
(10) Pub. No.: US 2026/0153708 A1
(43) Pub. Date: Jun. 4, 2026

(54) LENS APPARATUS AND IMAGE PICKUP APPARATUS

(71) Applicant: CANON KABUSHIKI KAISHA, Tokyo (JP)

(72) Inventor: Fumihiro SHINOBU, Tochigi (JP)

(21) Appl. No.: 19/396,428

(22) Filed: Nov. 21, 2025

(30) Foreign Application Priority Data
Nov. 29, 2024 (JP) 2024-208503

(51) Int. Cl. G02B 13/00; G02B 3/00; G02B 13/02

(52) U.S. Cl. CPC G02B 13/0045; G02B 13/02; G02B 2003/0093

(57) ABSTRACT

A lens apparatus includes in order from object side to image side: a first lens unit having a positive refractive power; a second lens unit having a positive refractive power and moving for focusing; and a third lens unit, wherein an interval between adjacent lens units is changed during focusing, in which the first lens unit includes, in order from object side to image side, two meniscus positive lenses each having a convex surface on the object side arranged consecutively, in which the first lens unit includes a first negative lens, in which refractive index, Abbe number of the first negative lens for d-line, partial dispersion ratio of the first negative lens with respect to the g-line, a distance on an optical axis from a lens surface closest to the image side to an image plane, and a focal length of the lens apparatus at infinity are properly set.

### BACKGROUND

### Field of the Technology

The disclosure relates to a lens apparatus and an image pickup apparatus.

### Description of the Related Art

In recent years, a lens apparatus used in an image pickup apparatus has been required to satisfactorily correct various aberrations along with an increase in performance of an image pickup element. In particular, chromatic aberration, curvature of field, and the like are likely to occur in an intermediate telephoto lens having a large aperture, and it is necessary to suppress the chromatic aberration, the curvature of field, and the like. As a lens apparatus satisfying these requirements, there is disclosed a lens apparatus including, in order from the object side to the image side, a first lens unit having a positive refractive power, a focus lens unit having a positive refractive power, and a third lens unit having a positive or negative refractive power.

Japanese Patent Laid-Open No. 2021-085935 discloses a lens apparatus that is designed to be reduced in size and weight while correcting various aberrations such as chromatic aberration.

However, in the lens apparatus disclosed in Japanese Patent Laid-Open No. 2021-085935, since the glass material used for a negative lens included in the first lens unit has relatively high refraction and high dispersion, a larger number of lenses are required to suppress chromatic aberration and curvature of field.

### SUMMARY

The disclosure provides a lens apparatus having a large aperture and a middle telephoto, which is small in size and can satisfactorily correct chromatic aberration and curvature of field.

A lens apparatus according to one aspect of the disclosure includes in order from an object side to an image side a first lens unit having a positive refractive power, a second lens unit having a positive refractive power, and a third lens unit, in which an interval between adjacent lens units is changed during focusing, the second lens unit is moved during focusing, the first lens unit includes two meniscus positive lenses having a convex surface on the object side in order from the object side to the image side adjacent to each other, and the first lens unit includes a first negative lens having a negative refractive power, following inequalities are satisfied,

$$1.5 < ndb 1 n$$

$$ndb 1 n + 0.015 \times vdb 1 n < 2.35$$

$$26. < vdb 1 n < 60.$$

$$- 0.1 \; 00 < θ gFb 1 n - ( - 9.529 \times 1 {0}^{- 8} \times vdb 1 {n}^{3} + 3.694 \times 1 {0}^{- 5} \times vdb 1 {n}^{2} - 4.717 \times 1 {0}^{- 3} \times vdb 1 n + 7.139 \times 1 {0}^{- 1} ) < 0.0 \; 00$$

$$0.03 < Bf / f < 0.4$$

where ndb1n represents a refractive index of the first negative lens at the d-line, vdb1n represents an Abbe number of the first negative lens at the d-line, θgFb1n represents a partial dispersion ratio of the first negative lens with respect to the g-line, Bf represents a distance on the optical axis from a lens surface closest to an image side to an image plane, and f represents a focal length of the lens apparatus at focusing at infinity.

A lens apparatus according to another aspect of the disclosure includes, in order from an object side to an image side, a first lens unit having a positive refractive power, a second lens unit having a positive refractive power, and a third lens unit, in which an interval between adjacent lens units is changed during focusing, the second lens unit is moved during focusing, and the first lens unit includes a negative meniscus lens having a convex surface on the object side.

Features of the present disclosure will become apparent from the following description of embodiments with reference to the attached drawings. The following description of embodiments is described by way of example.

### BRIEF DESCRIPTION OF THE DRAWINGS

FIG. 1 is a cross-sectional view of a lens apparatus according to Embodiment 1 in the infinity focus state.

FIG. 2 is an aberration diagram of the lens apparatus according to Embodiment 1 in the infinity focus state.

FIG. 3 is a cross-sectional view of a lens apparatus according to Embodiment 2 in the infinity focus state.

FIG. 4 is an aberration diagram of the lens apparatus according to Embodiment 2 in the infinity focus state.

FIG. 5 is a cross-sectional view of a lens apparatus according to Embodiment 3 in the infinity focus state.

FIG. 6 is an aberration diagram of the lens apparatus according to Embodiment 3 in the infinity focus state.

FIG. 7 is a cross-sectional view of a lens apparatus according to Embodiment 4 in the infinity focus state.

FIG. 8 is an aberration diagram of the lens apparatus according to Embodiment 4 in the infinity focus state.

FIG. 9 is a cross-sectional view of a lens apparatus according to Embodiment 5 in the infinity focus state.

FIG. 10 is an aberration diagram of the lens apparatus according to Embodiment 5 in the infinity focus state.

FIG. 11 is a cross-sectional view of a lens apparatus according to Embodiment 6 in the infinity focus state.

FIG. 12 is an aberration diagram of the lens apparatus according to Embodiment 6 in the infinity focus state.

FIG. 13 is a cross-sectional view of a lens apparatus according to Embodiment 7 in the infinity focus state.

FIG. 14 is an aberration diagram of the lens apparatus according to Embodiment 7 in the infinity focus state.

FIG. 15 is a cross-sectional view of a lens apparatus according to Embodiment 8 in the infinity focus state.

FIG. 16 is an aberration diagram of the lens apparatus according to Embodiment 8 in the infinity focus state.

FIG. 17 is a cross-sectional view of a lens apparatus according to Embodiment 9 in the infinity focus state.

FIG. 18 is an aberration diagram of the lens apparatus according to Embodiment 9 in the infinity focus state.

FIG. 19 is a cross-sectional view of a lens apparatus according to Embodiment 10 in the infinity focus state.

FIG. 20 is an aberration diagram of the lens apparatus according to Embodiment 10 in the infinity focus state.

FIG. 21 is a cross-sectional view of a lens apparatus according to Embodiment 11 in the infinity focus state.

FIG. 22 is an aberration diagram of the lens apparatus according to Embodiment 11 in the infinity focus state.

FIG. 23 is a cross-sectional view of a lens apparatus according to Embodiment 12 in the infinity focus state.

FIG. 24 is an aberration diagram of the lens apparatus according to Embodiment 12 in the infinity focus state.

FIG. 25 is a cross-sectional view of a lens apparatus according to Embodiment 13 in the infinity focus state.

FIG. 26 is an aberration diagram of the lens apparatus according to Embodiment 13 in the infinity focus state.

FIG. 27 is a cross-sectional view of a lens apparatus according to Embodiment 14 in the infinity focus state.

FIG. 28 is an aberration diagram of the lens apparatus according to Embodiment 14 in the infinity focus state.

FIG. 29 is a schematic diagram of an image pickup apparatus according to an embodiment of the disclosure.

### DESCRIPTION OF THE EMBODIMENTS

Hereinafter, a lens apparatus of the disclosure will be described in detail with reference to the accompanying drawings. In the drawings, the same reference numerals denote the same members, and a repetitive description thereof will not be given. Each of the embodiments of the present disclosure described below can be implemented solely or as a combination of a plurality of the embodiments or features thereof where necessary or where the combination of elements or features from individual embodiments in a single embodiment is beneficial.

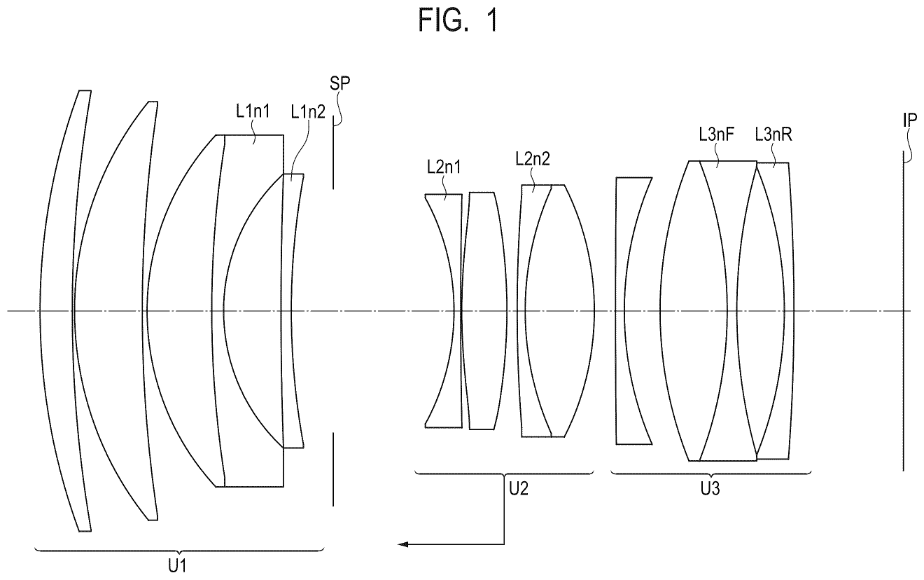

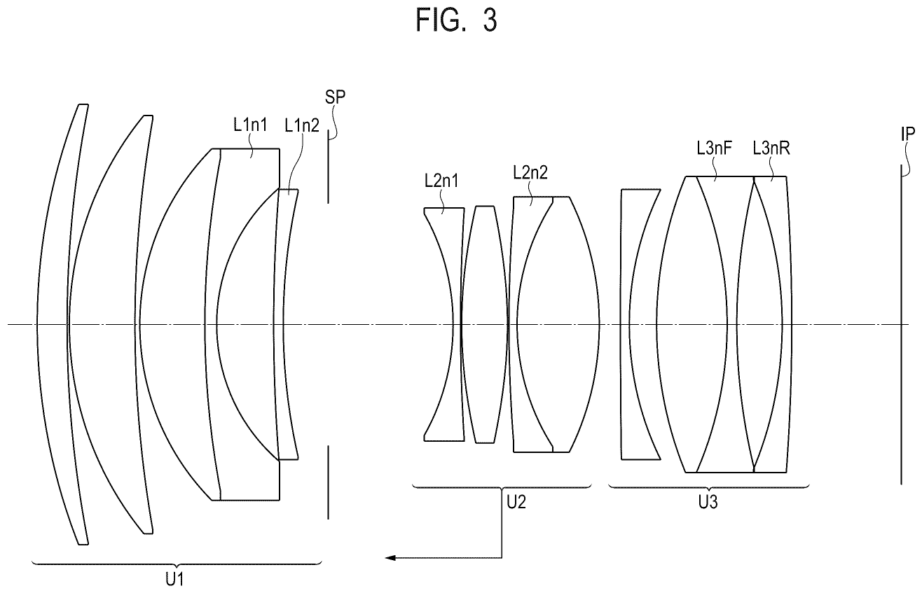

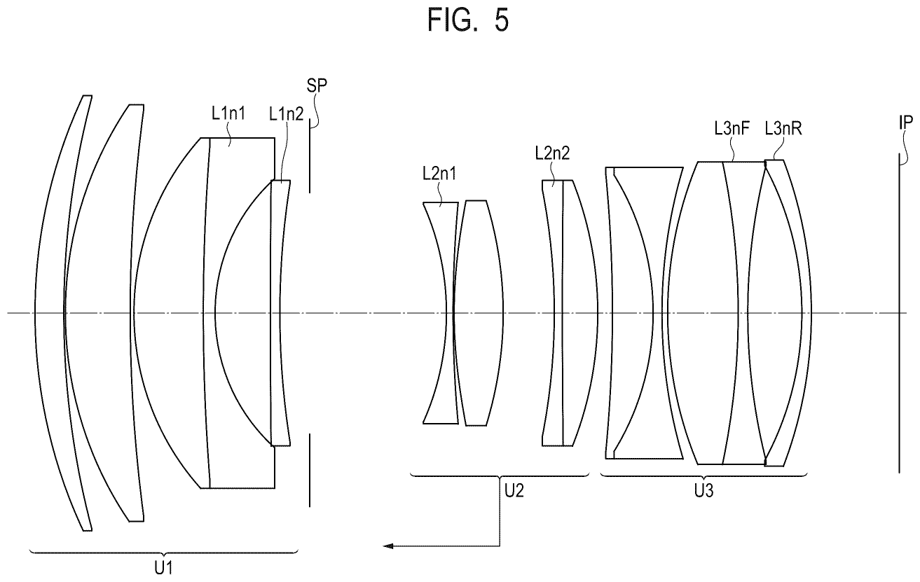

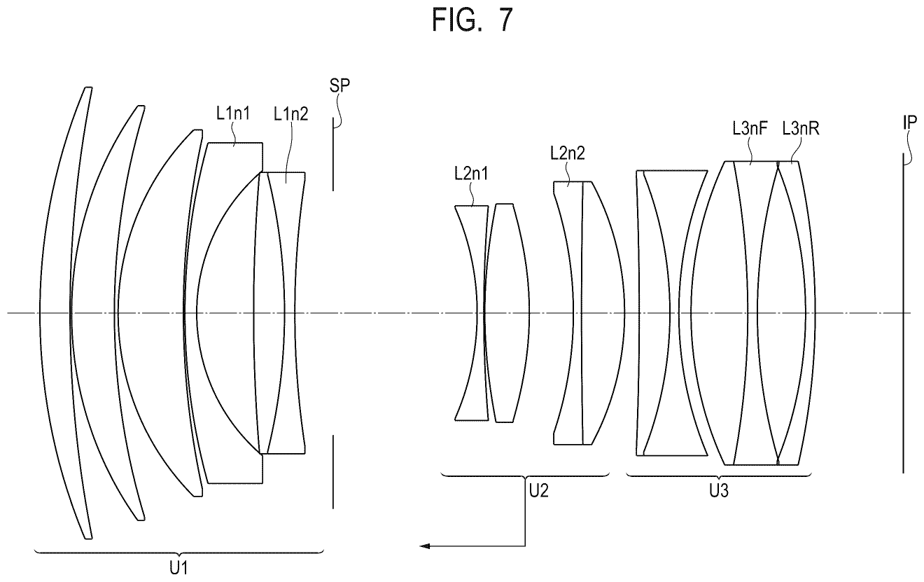

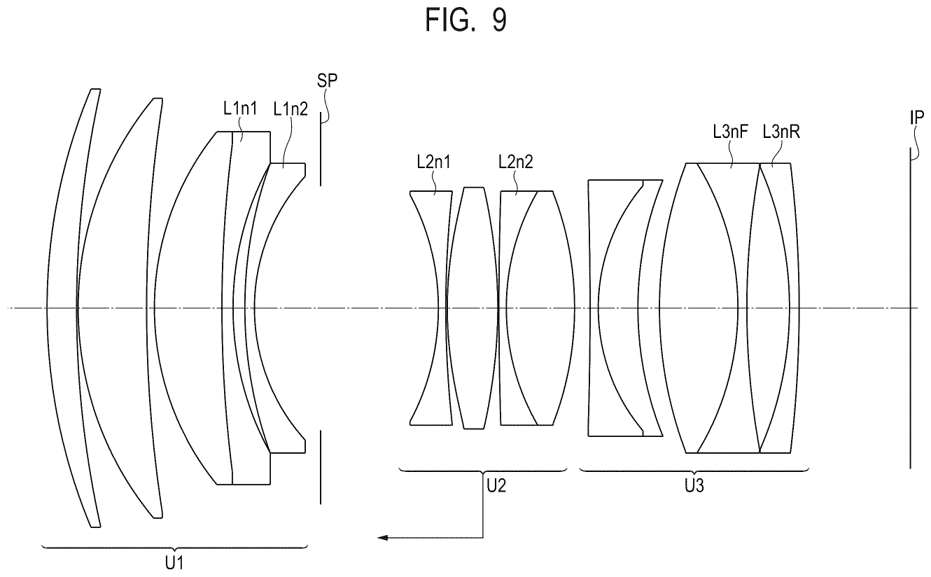

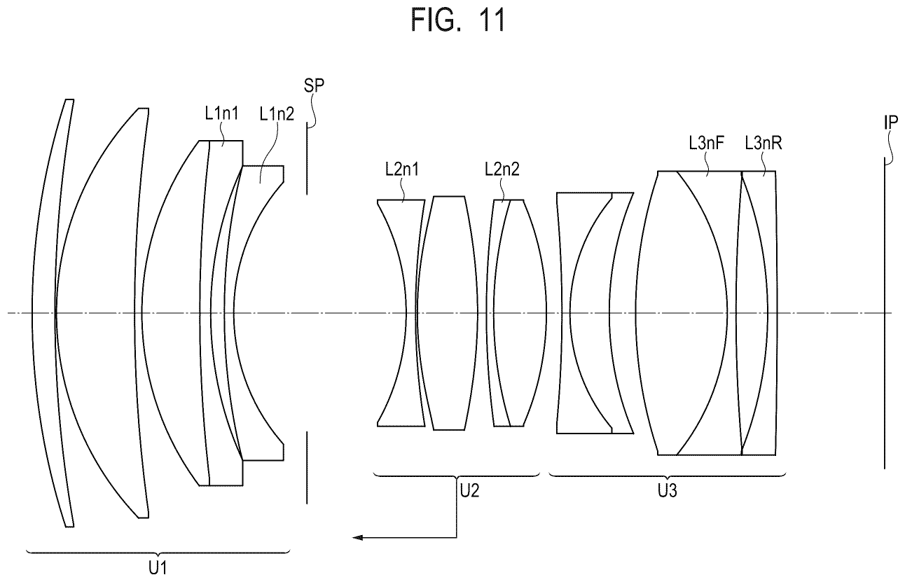

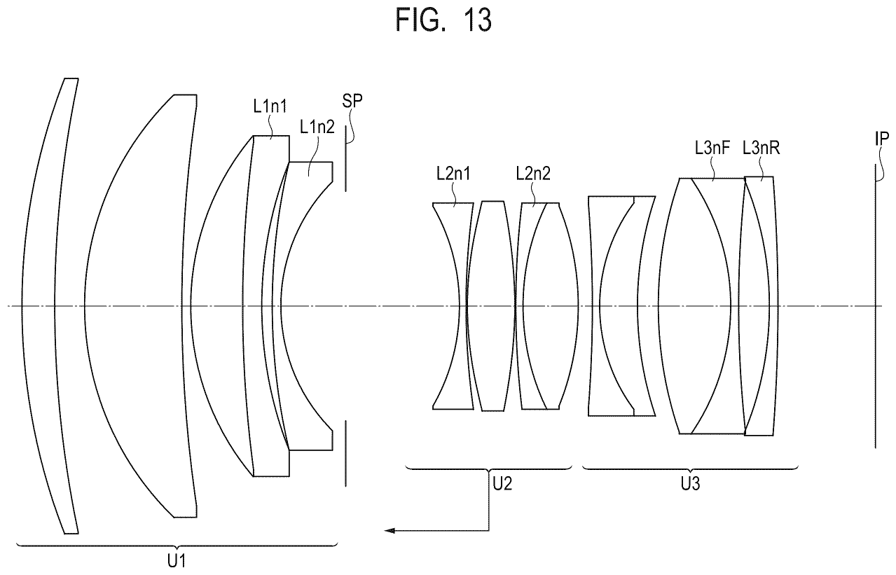

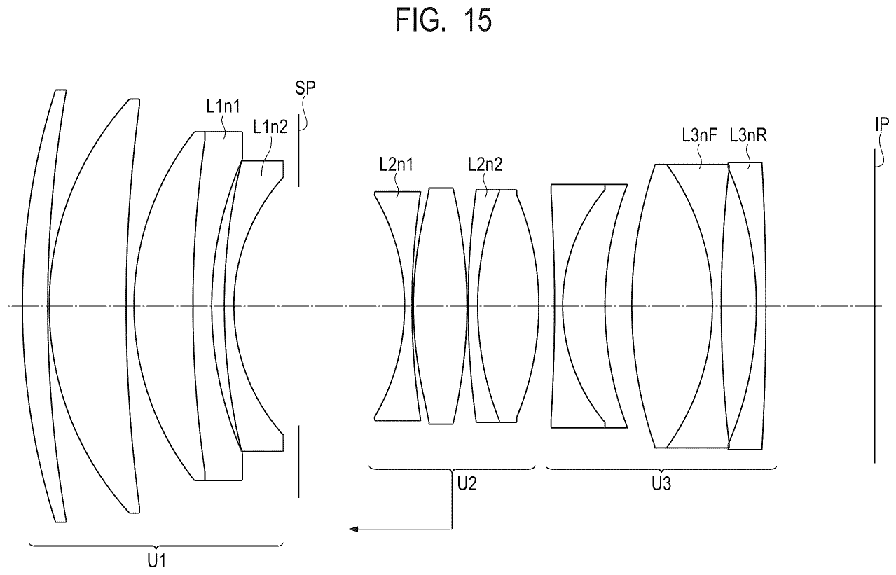

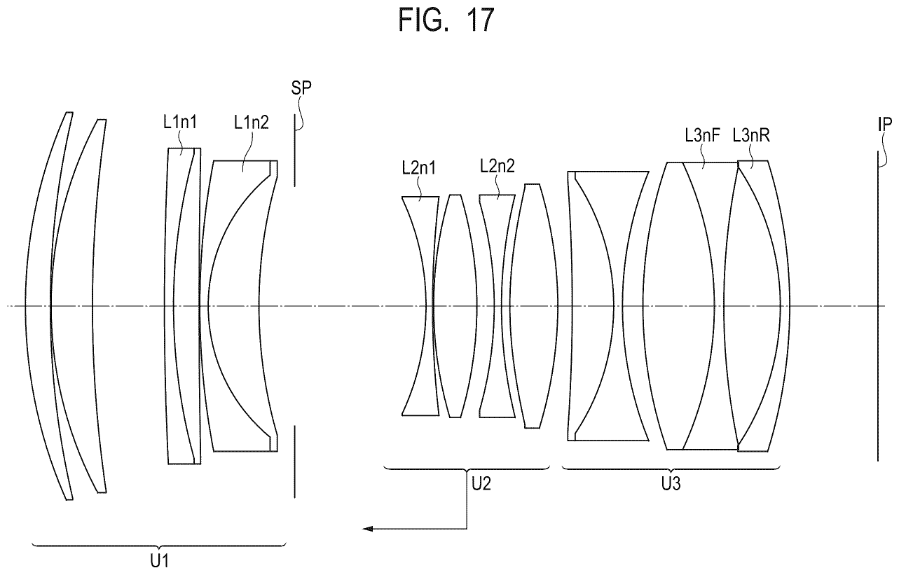

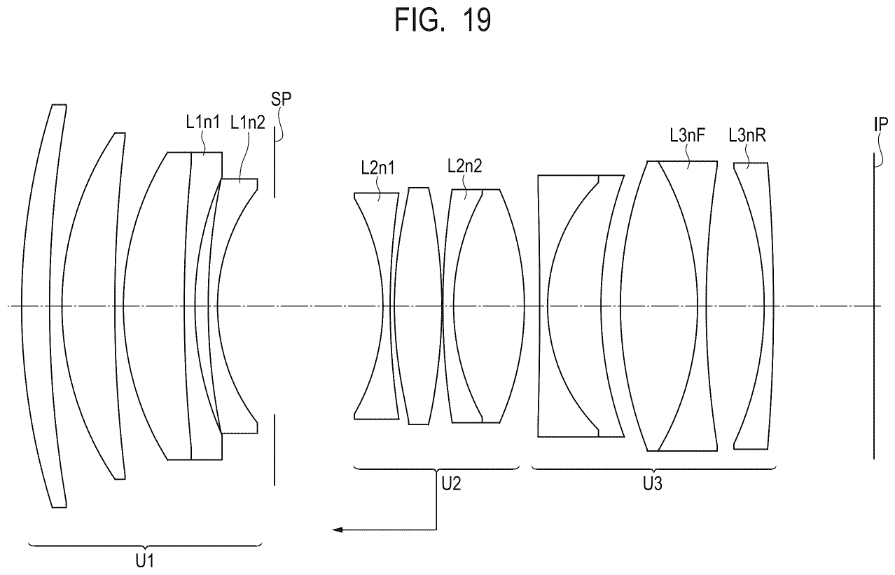

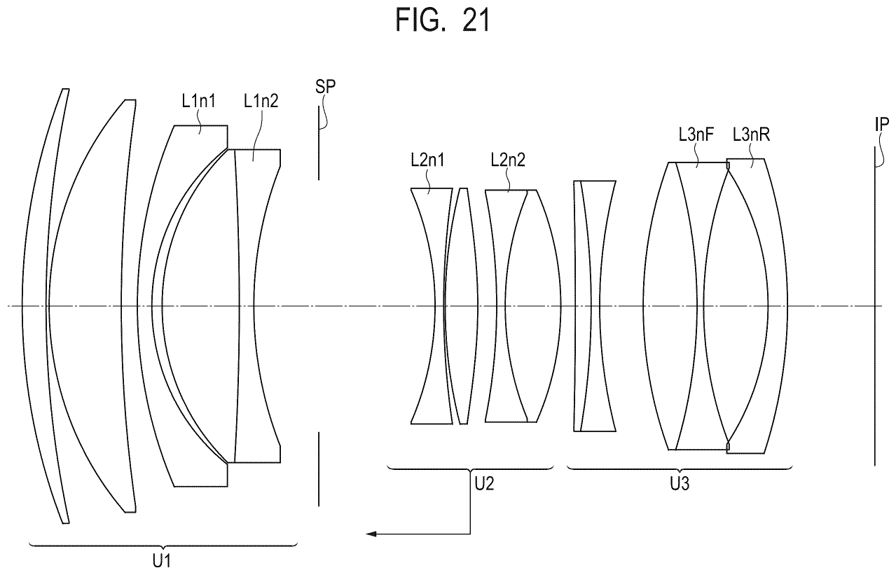

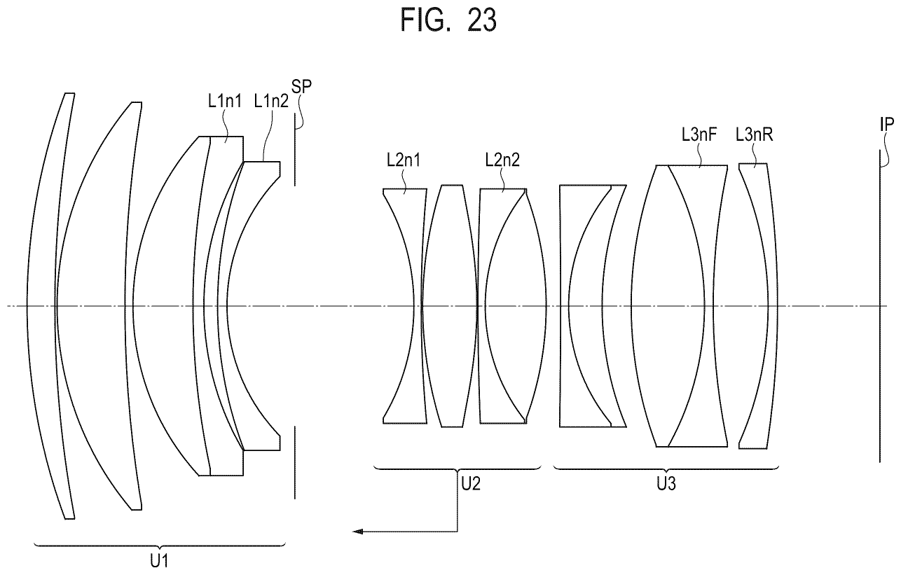

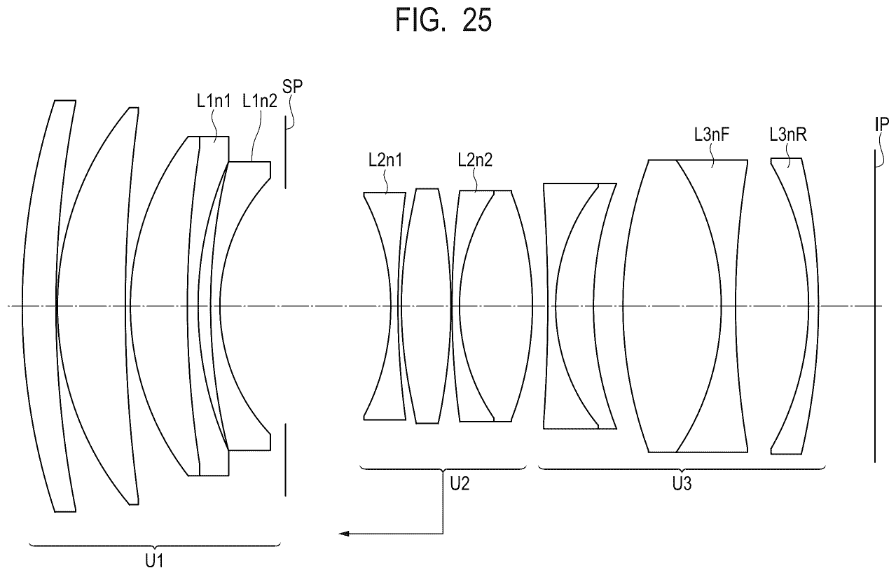

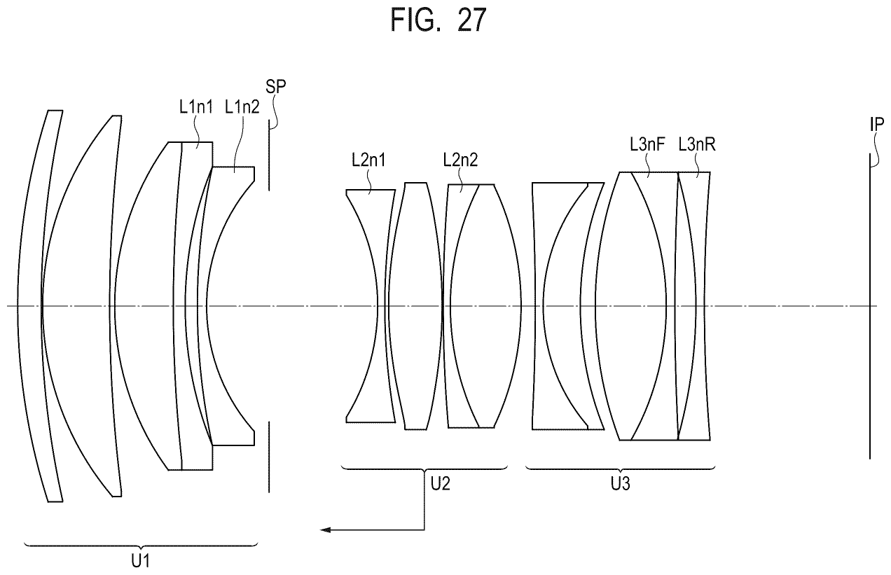

FIGS. 1, 3, 5, 7, 9, 11, 13, 15, 17, 19, 21, 23, 25 and 27 are cross-sectional views of the lens apparatuses of Embodiments 1 to 14 in the infinity focus state. The lens apparatus of each embodiment is a lens apparatus used in an image pickup apparatus such as a digital video camera, a digital still camera, a broadcasting camera, a silver-halide film camera, or a monitoring camera.

In each cross-sectional view, the left side is the object side, and the right side is the image side. The lens apparatus of each embodiment includes a plurality of lens units. In the present specification, a lens unit is a unit of lenses that integrally move or remain stationary during focusing. That is, in the lens apparatus of each embodiment, the interval between adjacent lens units is changed during focusing. Each lens unit may be composed of one lens or a plurality of lenses.

The lens apparatus of each embodiment includes, in order from the object side to the image side, a first lens unit U1 having a positive refractive power, a second lens unit U2 having a positive refractive power, and a third lens unit U3 having a positive or negative refractive power.

Reference numeral SP denotes an aperture stop. IP denotes an image plane, and when the lens apparatus of each embodiment is used as an image pickup lens apparatus of a digital still camera or a digital video camera, an image plane of a solid-state image pickup element (photoelectric conversion element) such as a CCD sensor or a CMOS sensor is disposed. When the lens apparatus of each embodiment is used as a photographic lens apparatus of a silver-halide film camera, a photosensitive surface corresponding to a film surface is placed on the image plane IMG.

The arrows shown in the cross-sectional views indicate the movement directions of the lens units during focusing from infinity to the closest distance. In the lens apparatus of each embodiment, the second lens unit U2 is moved toward the object side and the first lens unit U1 and the third lens unit U3 are mot moved during focusing from infinity to the closest distance.

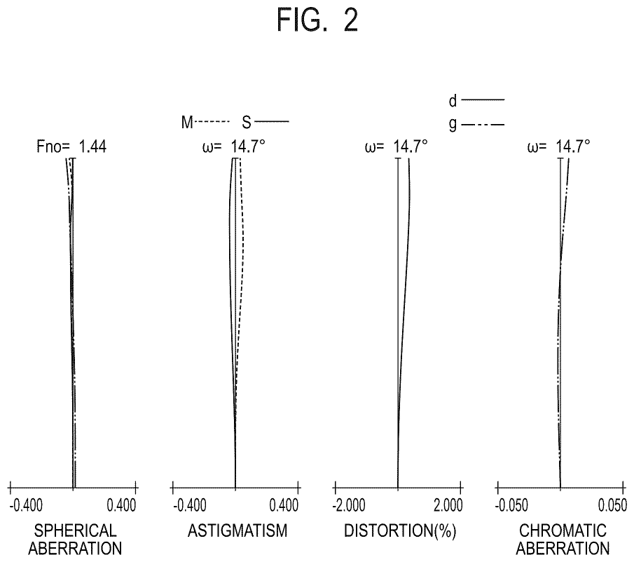

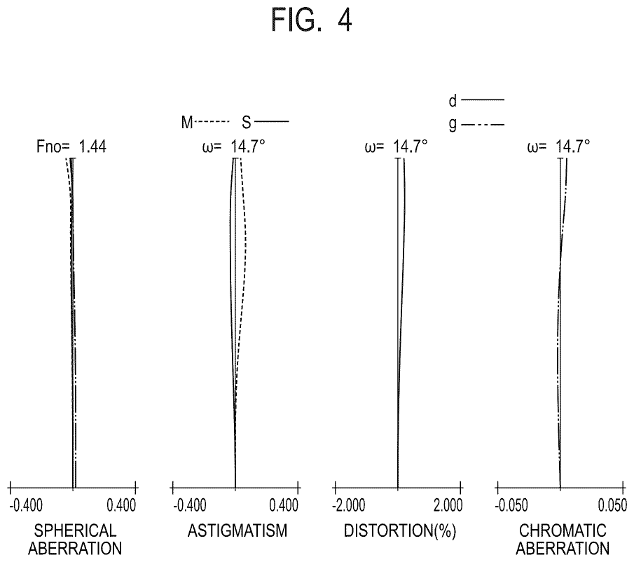

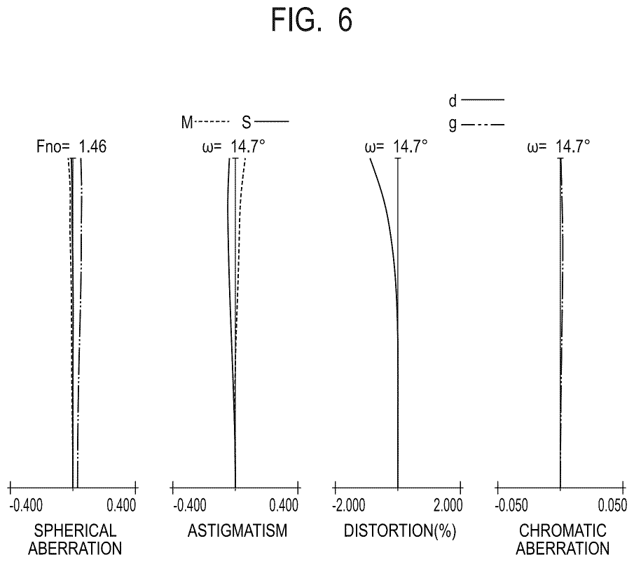

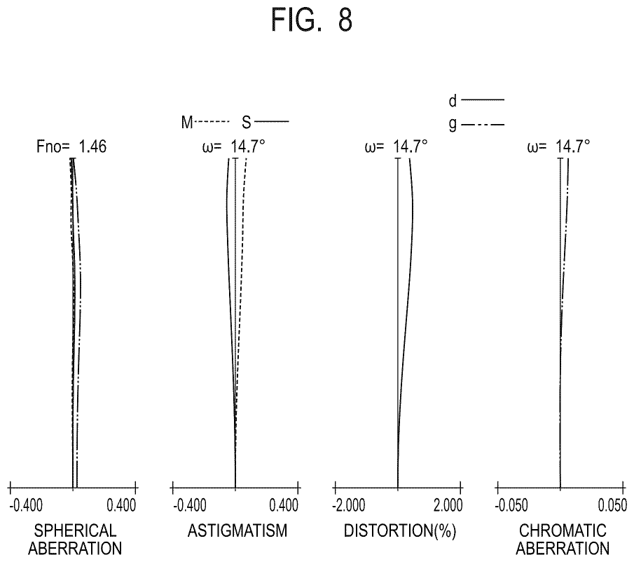

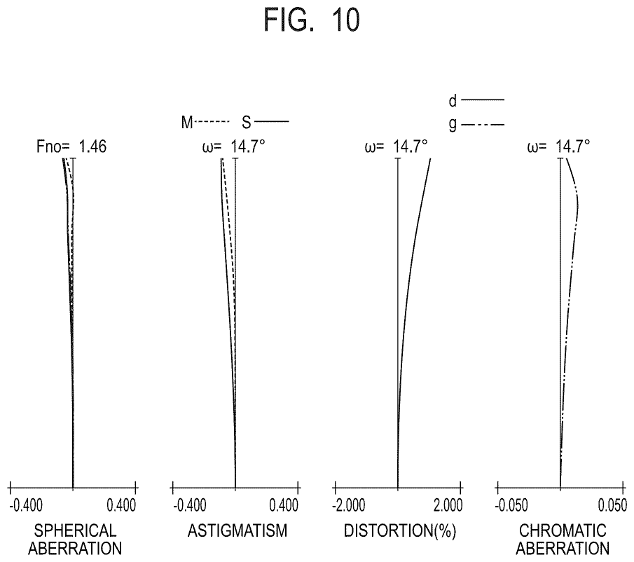

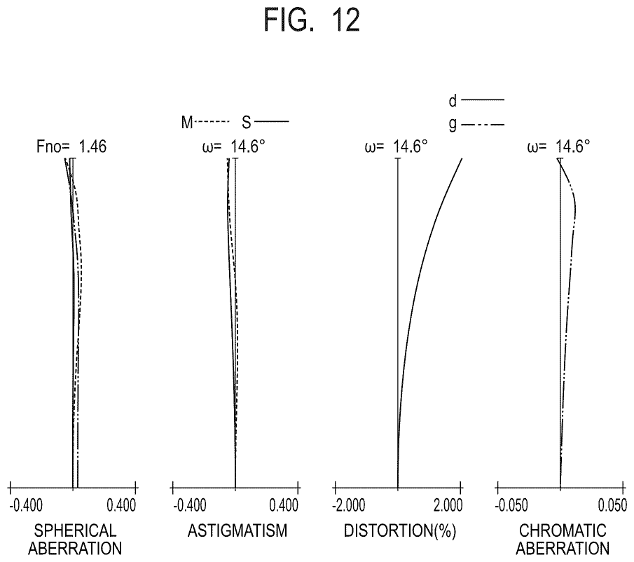

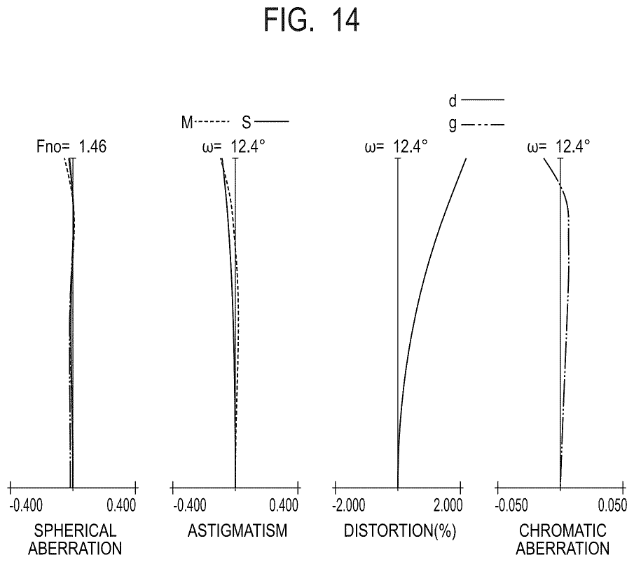

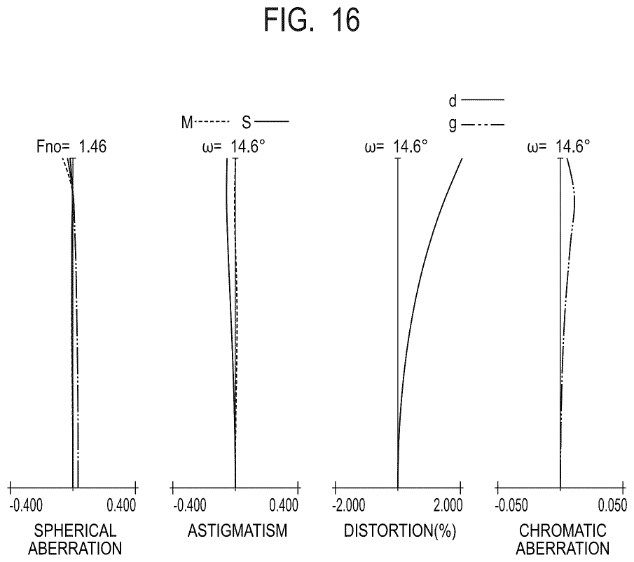

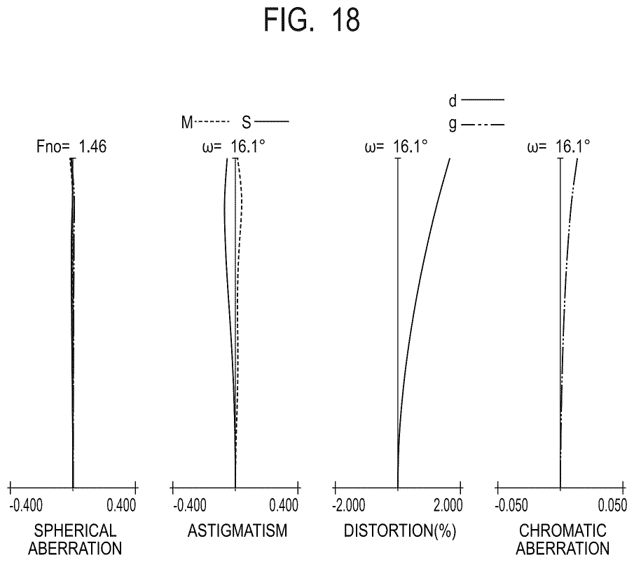

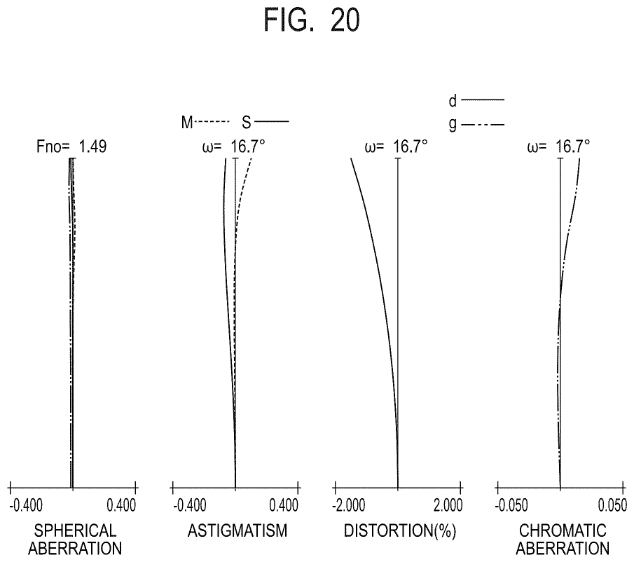

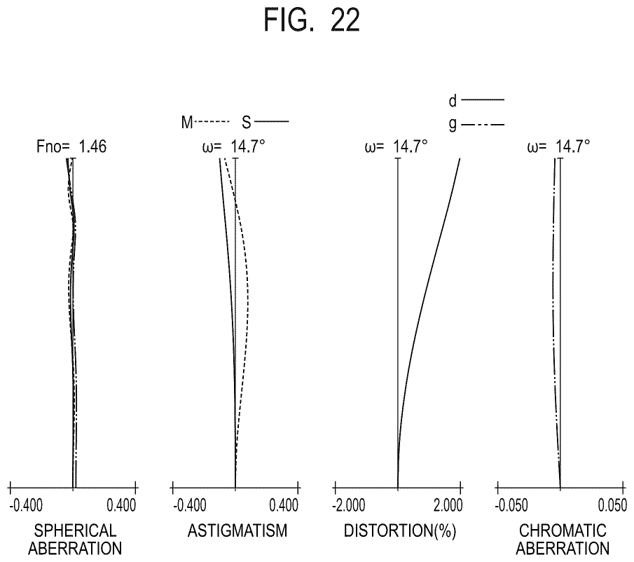

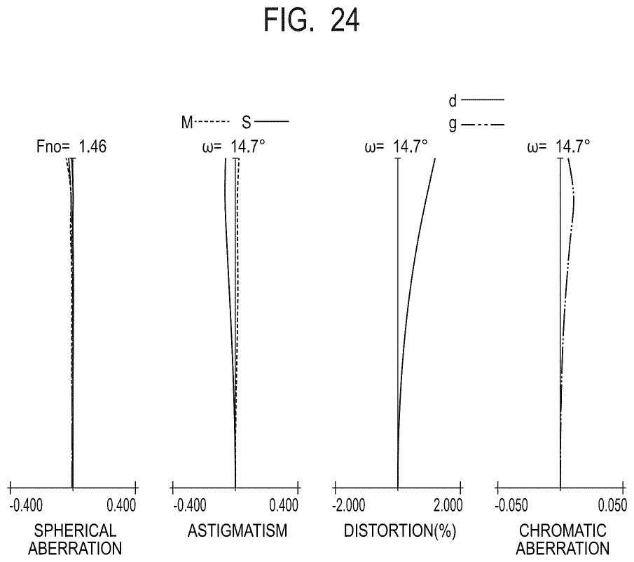

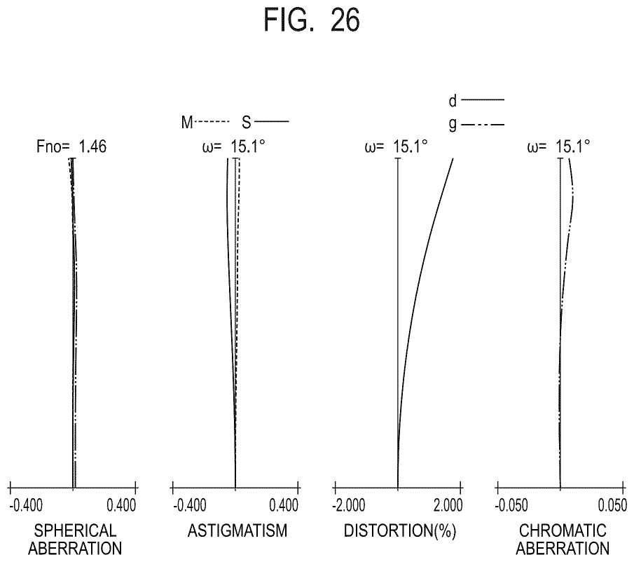

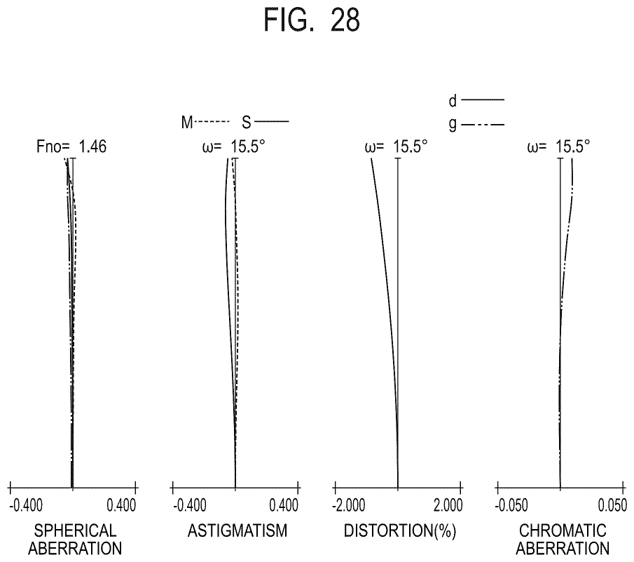

FIGS. 2, 4, 6, 8, 10, 12, 14, 16, 18, 20, 22, 24, 26 and 28 are aberration diagrams of the lens apparatuses of Embodiments 1 to 14 in the infinity focus state. In the spherical aberration diagram, Fno represents an F-number and the amount of spherical aberration with respect to the d-line (wavelength: 587.6 nm) and the g-line (wavelength: 435.8 nm) are indicated. In the astigmatism diagram, S represents the amount of astigmatism on the sagittal image plane, and M represents the amount of astigmatism on the meridional image plane. In the distortion diagram, the amount of distortion with respect to the d-line is shown. The chromatic aberration diagram shows the amount of chromatic aberration at the g-line. ω represents an image pickup half angle of view (degrees).

Next, a characteristic configuration of the lens apparatus of each embodiment will be described.

In the lens apparatus of each embodiment, two meniscus positive lenses having a convex surface on the object side are continuously disposed in the first lens unit U1 in order from the object side, and at least two negative lenses are included in the first lens unit U1. In an intermediate telephoto lens having a large aperture, chromatic aberration is particularly conspicuous, and on the other hand, if a lens arrangement that focuses on correction of chromatic aberration is selected, curvature of field also becomes insufficiently corrected, and therefore, an appropriate lens arrangement that balances both is necessary.

In the lens apparatus of each embodiment, the first lens unit includes a first negative lens having a negative refractive power, the following inequalities are satisfied,

$$1.5 < ndb 1 n \qquad ( 1 )$$

$$Ndb 1 n + 0.015 \times vdb 1 n < 2.35 \qquad ( 2 )$$

$$26. < vdb 1 n < 60. \qquad ( 3 )$$

$$- 0.1 \; 00 < θ gFb 1 n - ( - 9.529 \times 1 {0}^{- 8} \times vdb 1 {n}^{3} + 3.694 \times 1 {0}^{- 5} \times vdb 1 {n}^{2} - 4.717 \times 1 {0}^{- 3} \times vdb 1 n + 7.139 \times 1 {0}^{- 1} ) < 0.0 \; 00 \qquad ( 4 )$$

$$0.03 < Bf / f < 0.40 \qquad ( 5 )$$

where ndb1n represents the refractive index of the first negative lens at the d-line, vdb1n represents the Abbe number of the first negative lens at the d-line, θgFb1n represents the partial dispersion ratio of the first negative lens with respect to the g-line, Bf represents the distance on the optical axis from the lens surface closest to the image side of the lens apparatus to the image plane, and f represents the focal length of the lens apparatus in the infinity focus state.

The inequality (1) defines the refractive index of the first negative lens included in the first lens unit U1. If the lower limit of the inequality (1) is not satisfied, the curvature of the first negative lens becomes too strong, which makes it difficult to suppress spherical aberration and coma.

The inequality (2) defines the relationship between the refractive index and the Abbe number of the first negative lens included in the first lens unit U1. If the upper limit of inequality (2) is not satisfied, the Petzval sum of the lens apparatus increases to the positive side, which makes it difficult to correct the curvature of field.

The inequality (3) defines the Abbe number of the first negative lens included in the first lens unit U1. If the lower limit of the inequality (3) is not satisfied, the dispersion by the first negative lens becomes too strong, and a large number of lenses are required to correct the dispersion, resulting in an increase in the size of the lens apparatus, which is not preferable. If the upper limit of the inequality (3) is not satisfied, the dispersion of the first negative lens is too weak, which makes it difficult to correct chromatic aberration.

The inequality (4) defines a partial dispersion ratio of the first negative lens included in the first lens unit U1. If the lower limit of inequality (4) is not satisfied, chromatic aberration for the g-line is excessively corrected, which is not preferable. If the upper limit of the inequality (4) is not satisfied, the chromatic aberration for the g-line becomes insufficiently corrected, which is not preferable.

The inequality (5) defines the ratio of the back focus relative to the focal length of the lens apparatus. If the lower limit of the inequality (5) is not satisfied, the incident angle of beams on the image pickup surface becomes too large, which makes it difficult for the image pickup element to receive light, which is not preferable. If the upper limit of inequality (5) is not satisfied, an appropriate lens arrangement for correcting chromatic aberration of magnification in a region where the image height is high cannot be performed, and correction becomes insufficient, which is not preferable.

As shown in Table 1, in each embodiment, the two first negative lenses L1n1 and L1n2 in the first lens unit U1 satisfy the inequalities (1) to (4).

It is preferable to satisfy the inequality (1) in which the lower limit value is changed to 1.52. It is further preferable to satisfy the inequality (1) in which the lower limit is changed to 1.55, 1.59, 1.61, or 1.63.

It is preferable to satisfy the inequality (2) in which the upper limit value of the inequality (2) is changed to 2.34. It is further preferable to satisfy the inequality (2) in which the upper limit is changed to 2.33, 2.32, or 2.30.

It is preferable to satisfy the inequality (3) in which the lower limit value is changed to 26.5. It is further preferable to satisfy the inequality (3) in which the lower limit value is changed to 27.0, 28.0, 28.5, or 29.0. It is preferable to satisfy the inequality (3) in which the upper limit is changed to 55.0. It is further preferable to satisfy the inequality (3) in which the upper limit value is changed to 50.0, 45.0, 40.0, or 38.0.

It is preferable to satisfy the inequality (4) in which the lower limit value is changed to −0.030. It is further preferable to satisfy the inequality (4) in which the lower limit is changed to −0.010, −0.0095, or −0.009. It is preferable to satisfy the inequality (4) in which the upper limit is changed to −0.002. It is further preferable to satisfy the inequality (4) in which the upper limit is changed to −0.003, −0.004, or −0.005.

It is preferable to satisfy the inequality (5) in which the lower limit value is changed to 0.05. It is further preferable to satisfy the inequality (5) in which the lower limit is changed to 0.08, 0.01, 0.12, 0.13, or 0.15. It is preferable to satisfy the inequality (5) in which the upper limit is changed to 0.35. It is further preferable to satisfy the inequality (5) in which the upper limit is changed to 0.30, 0.25, or 0.20.

Next, a configuration that is preferably satisfied in the lens apparatus of each embodiment will be described.

In the first lens unit U1, a lens disposed as a third lens counted from the object side is preferably a meniscus lens having a convex surface on the object side. In an intermediate telephoto lens having a large aperture, the refractive power of the lens apparatus as a whole is relatively weak, and when a lens having extremely strong power is disposed, it becomes difficult to correct aberrations. Therefore, it is desirable to gently refract the light beam by a meniscus lens having a convex surface on the object side. For the same reason, in the first lens unit U1, a lens disposed as a fourth lens counted from the object side is preferably a meniscus lens having a convex surface on the object side. Similarly, in the first lens unit U1, a lens disposed as a fifth lens counted from the object side is preferably a meniscus lens having a convex surface on the object side.

It is preferable that the first lens unit U1 include a negative meniscus lens having a convex surface on the object side.

The second lens unit U2 preferably includes at least three lenses. Although the second lens unit U2 is a moving lens unit during focusing, it is necessary to correct aberrations in the moving lens unit in order to reduce distance variation due to a focusing position in spherical aberration, curvature of field, and variation in angle of view of the lens apparatus. By arranging three or more lenses in the second lens unit U2, it is possible to suppress distance fluctuations in spherical aberration and coma in the lens apparatus.

In the second lens unit U2, it is preferable to dispose at least one aspheric lens in the lens unit. In an intermediate telephoto lens having a large aperture, by disposing an aspherical lens in the central portion of the lens apparatus, it is possible to suppress aberrations such as spherical aberration and coma, and to effectively suppress distance fluctuation.

In the second lens unit U2, a lens disposed closest to the object side preferably has a negative refractive power. This facilitates suppression of Petzval sum and correction of axial chromatic aberration.

In addition, it is preferable that an aperture stop in the lens apparatus of each embodiment is disposed between the first lens unit U1 and the second lens unit U2. As a result, it is possible to suppress the distance fluctuation of various aberrations such as curvature of field and coma of the lens apparatus due to the focus position.

Next, inequalities that are preferably satisfied by the lens apparatus of each embodiment will be described. It is preferable that the lens apparatus of each embodiment satisfies at least one or more of the following inequalities (6) to (35).

$$1. < f 1 / f < 5. \qquad ( 6 )$$

$$0.3 < f 2 / f < 1.5 \qquad ( 7 )$$

$$- 2. 0 < f / f 3 < 1. \qquad ( 8 )$$

$$0.1 < f 2 / f 1 < 0.7 \qquad ( 9 )$$

$$- 1. < f 2 / f 3 < 0 \text{.50} \qquad ( 10 )$$

$$1. 60 < nd 1 < 2.5 \qquad ( 11 )$$

$$13. 0 < vd 1 < 50. \qquad ( 12 )$$

$$0.15 < f g 2 / fg 1 < 1.5 \qquad ( 13 )$$

$$0.5 < ( b3 F R b 2 L R ) / ( b 3 F R - b 2 L R ) < 2.50 \qquad ( 14 )$$

$$15. 0 < vdb 3 L 1 < 90. \qquad ( 15 )$$

$$- 0. 05 < θ g F b 3 L 1 ( - 9.529 \times 1 {0}^{- 8} \times v d b 3 L {1}^{3} + 3.694 \times 1 {0}^{- 5} \times v d b 3 L {1}^{2} - 4.717 \times 1 {0}^{- 3} \times vdb 3 L 1 + 7.139 \times 1 {0}^{- 1} ) < 0.0 \; 25 \qquad ( 16 )$$

$$20. < vdb 3 L 2 < 90. 0 \qquad ( 17 )$$

$$- 0. 05 < θ g F b 3 L 2 ( - 9.529 \times 1 {0}^{- 8} \times v d b 3 L {2}^{3} + 3.694 \times 1 {0}^{- 5} \times v d b 3 L {2}^{2} - 4.717 \times 1 {0}^{- 3} \times v d b 3 L 2 + 7.139 \times 1 {0}^{- 1} ) < 0 \text{.025} \qquad ( 18 )$$

$$0. 20 < \vert R min \vert / f < 0.6 \qquad ( 19 )$$

$$0. < ( tan ( ObD\_inf ) / tan ( ObjD\_mod ) - 1 ) \times 100 < 10. \qquad ( 20 )$$

$$26. < vdb 1 n\_ave < 60. \qquad ( 21 )$$

$$0.9 < ndgn 2 / ndgn 1 < 1.3 \qquad ( 22 )$$

$$- 0.3 \; 0 < M 2 / f < - 0.03 \qquad ( 23 )$$

$$- 1. < f n o \times f 2 / f 3 < 0 \text{.30} \qquad ( 24 )$$

$$- 0.1 \; 00 < θ g F b 2 n - ( - 9.529 \times 1 {0}^{- 8} \times v d b 2 {n}^{3} + 3.694 \times 1 {0}^{- 5} \times v d b 2 {n}^{2} - 4.717 \times 1 {0}^{- 3} \times v d b 2 n + 7.139 \times 1 {0}^{- 1} ) < 0.0 \; 00 \qquad ( 25 )$$

$$0. 20 < β2 < 0.7 \qquad ( 26 )$$

$$0.7 < β3 < 1.7 \qquad ( 27 )$$

$$0. 45 < ( 1 - {β2}^{2} ) \times β {3}^{2} < 2.00 \qquad ( 28 )$$

$$5. 00 < f 1 / Bf < 30.00 \qquad ( 29 )$$

$$1. 00 < f 2 / Bf < 10.00 \qquad ( 30 )$$

$$- 0.3 \; 0 < B f / f 3 < 0.10 \qquad ( 31 )$$

$$0. 200 < Lb 23 / f < 0.5 \; 00 \qquad ( 32 )$$

$$1. 20 < fP 1 / f < 5. \qquad ( 33 )$$

$$0.5 < fP 2 / f < 1.10 \qquad ( 34 )$$

$$0.1 < f P 2 / fP 1 < 0.8 \qquad ( 35 )$$

Here, f1 represents the focal length of the first lens unit U1, f2 represents the focal length of the second lens unit U2, and f3 represents the focal length of the third lens unit U3. The refractive index and the Abbe number with respect to the d-line of the lens disposed closest to the object side in the first lens unit U1 are denoted by nd1 and vd1. A focal length of a lens disposed closest to the object side in the first lens unit U1 is denoted by fg1, and a focal length of a lens disposed secondary closest to the object side in the first lens unit U1 is denoted by fg2. The curvature radius of a lens surface closest to the image side in the second lens unit U2 is denoted by b2LR, and the curvature radius of a lens surface closest to the object side in the third lens unit U3 is denoted by b3FR.

The third lens unit U3 has a third R negative lens L3nR having a negative refractive power disposed closest to the image side, and the Abbe number of the third R negative lens L3nR with respect to the d-line is denoted by vdb3L1, and the partial dispersion ratio of the third R negative lens with respect to the g-line is denoted by θgFb3L1. The third lens unit U3 includes a third F negative lens L3 nF having a negative refractive power and disposed at the second position from the image side, and the Abbe number of the third F negative lens L3 nF with respect to the d-line is denoted by vdb3L2, and the partial dispersion ratio of the third F negative lens L3 nF with respect to the g-line is denoted by θgFb3L2. In the optical surfaces included in the first lens unit U1 and the third lens unit U3, the radius of curvature having the smallest absolute value is defined as Rmin.

In the lens apparatus, an angle of the object-side incident light passing through the center of the aperture stop in the infinity focus state and forming an image at 90% of the maximum image height is denoted by ObjD_inf, and an angle of the object-side incident light passing through the center of the aperture stop in the closest-distance focus state and forming an image at 90% of the maximum image height is denoted by ObjD_mod. An average value of the Abbe numbers of all the negative lenses disposed in the first lens unit U1 is denoted by vdb1n_ave. A refractive index of one of the negative lenses disposed in the first lens unit U1 is denoted by ndgn1, and a refractive index of the negative lens disposed closer to the image side than the negative lens is denoted by ndgn2. Assuming that the direction moving from the object side to the image side is positive, the amount of relative movement of the second lens unit U2 with respect to the image plane during focusing from infinity to the closest distance is denoted by M2.

An F number of the lens apparatus is denoted by fno. An Abbe number of at least one negative lens disposed in the second lens unit U2 is denoted by vdb2n, and the partial dispersion ratio thereof is denoted by θgFb2n. An imaging lateral magnification of the second lens unit U2 in the infinity focus state is denoted by β2. An imaging lateral magnification of the third lens unit U3 in the infinity focus state is denoted by β3. A distance on the optical axis from a surface closest to the image side of the first lens unit U1 to a surface closest to the object side of the second lens unit U2 in the infinity focus state is denoted by Lb23. A combined focal length of lenses disposed in the object side of the aperture stop in the lens apparatus is denoted by fP1. A combined focal length of lenses disposed closer to the image side than the aperture stop in the lens apparatus is denoted by fP2.

The inequality (6) defines the ratio of the focal length of the first lens unit U1 to the focal length of the entire system of the lens apparatus. If the lower limit of the inequality (6) is not satisfied, the power of the first lens unit U1 becomes too strong, which makes it difficult to correct spherical aberration, coma, and axial chromatic aberration. On the other hand, if the upper limit of the inequality (6) is not satisfied, the power of the first lens unit U1 becomes too weak, which makes it difficult to correct spherical aberration, coma, and axial chromatic aberration.

It is preferable to satisfy the inequality (6) in which the lower limit value is changed to 1.20. It is further preferable to satisfy the inequality (6) in which the lower limit value is changed to 1.30, 1.40, 1.50, or 1.60. It is preferable to satisfy the inequality (6) in which the upper limit value is changed to 4.50. It is further preferable to satisfy the inequality (6) in which the upper limit value is changed to 4.00, 3.50, 3.00, or 2.50.

The inequality (7) defines the ratio of the focal length of the second lens unit U2 to the focal length of the entire system of the lens apparatus. If the lower limit of the inequality (7) is not satisfied, the power of the second lens unit U2 becomes too strong, so that the distance variation of spherical aberration, coma, and curvature of field becomes large, which is not preferable. On the other hand, if the upper limit of the inequality (7) is not satisfied, the power of the second lens unit U2 becomes too weak, and the amount of movement of the second lens unit U2 during focusing becomes too large to extend the entire optical length, which is not preferable.

It is preferable to satisfy the inequality (7) in which the lower limit value is changed to 0.35. It is further preferable to satisfy the inequality (7) in which the lower limit of inequality (7) is changed to 0.40, 0.45, or 0.50. It is preferable to satisfy the inequality (7) in which the upper limit value is changed to 1.30. It is further preferable to satisfy the inequality (7) in which the upper limit value is changed to 1.20, 1.10, 1.00, 0.85 or 0.70.

The inequality (8) defines the ratio the focal length of the entire system of the lens apparatus to the focal length of the third lens unit U3. If the lower limit of the inequality (8) is not satisfied, the power of the third lens unit U3 becomes too strong, which makes it difficult to correct distortion and chromatic aberration of magnification, and the incident angle of a light beam on the image plane becomes strong, which is not preferable. If the upper limit of the inequality (8) is not satisfied, the power of the third lens unit U3 becomes too strong to correct coma, chromatic aberration of magnification, and Petzval sum, which is not preferable.

It is preferable to satisfy the inequality (8) in which the lower limit value is changed to −1.70. It is further preferable to satisfy the inequality (8) in which the lower limit value is changed to −1.50, −1.30, −1.10, or −0.90. It is preferable to satisfy the inequality (8) in which the upper limit value of the inequality (8) is changed to 0.50. It is further preferable to satisfy the inequality (8) in which the upper limit is changed to 0.30, 0.10, −0.10 or −0.30.

The inequality (9) defines the ratio of the focal length of the second lens unit U2 to the focal length of the first lens unit U1. If the lower limit of the inequality (9) is not satisfied, the power of the first lens unit U1 becomes too weak, which makes it difficult to correct spherical aberration, coma, and axial chromatic aberration. On the other hand, if the upper limit of the inequality (9) is not satisfied, the power of the second lens unit U2 becomes too weak, and the amount of movement of the second lens unit U2 during focusing becomes too large to extend the entire optical length, which is not preferable.

It is preferable to satisfy the inequality (9) in which the lower limit value is changed to 0.13. It is further preferable to satisfy the inequality (9) in which the lower limit value is changed to 0.15 or 0.17. It is preferable to satisfy the inequality (9) in which the upper limit value is changed to 0.60. It is further preferable to satisfy the inequality (9) in which the upper limit value is changed to 0.50, 0.40, or 0.35.

The inequality (10) defines the ratio of the focal length of the second lens unit U2 to the focal length of the third lens unit U3. If the lower limit of the inequality (10) is not satisfied, the power of the third lens unit U3 becomes too strong to be negative, which makes it difficult to correct distortion and chromatic aberration of magnification, and increases the incident angle of light rays on the image plane, which is not preferable. If the upper limit of the inequality (10) is not satisfied, the power of the third lens unit U3 becomes too strong to correct coma, chromatic aberration of magnification, and Petzval sum, which is not preferable.

It is preferable to satisfy the inequality (10) in which the lower limit value is changed to −0.70. It is further preferable to satisfy the inequality (10) in which the lower limit value is changed to −0.60, −0.50, or −0.40. It is preferable to satisfy the inequality (10) in which the upper limit value is changed to 0.40. It is further preferable to satisfy the inequality (10) in which the upper limit value is changed to 0.30, 0.20, or 0.10.

The inequality (11) and the inequality (12) define the refractive index, and the Abbe number of the lens disposed closest to the object side in the first lens unit U1. If the lower limit of the inequality (11) is not satisfied, the curvature of the lens disposed closest to the object side in the first lens unit U1 becomes strong, and it becomes difficult to correct spherical aberration and axial chromatic aberration, which is not preferable. If the upper limit of inequality (11) is not satisfied, the refractive power of the lens disposed closest to the object side of the first lens unit U1 becomes too strong, which makes it difficult to correct spherical aberration and coma. If the lower limit of the inequality (12) is not satisfied, the dispersion of the lens disposed closest to the object side in the first lens unit U1 becomes too strong, which makes it difficult to correct axial chromatic aberration and chromatic aberration of magnification, which is not preferable. If the upper limit of the inequality (12) is not satisfied, the dispersion of the lens disposed closest to the object side in the first lens unit U1 is too weak, so that the axial chromatic aberration and the chromatic aberration of magnification are insufficiently corrected, which is not preferable.

It is preferable to satisfy the inequality (11) in which the lower limit value is changed to 1.65. It is further preferable to satisfy the inequality (11) in which the lower limit value is changed to 1.70, 1.75, or 1.80. It is preferable to satisfy the inequality (11) in which the upper limit value is changed to 2.40. It is further preferable to satisfy the inequality (11) in which the upper limit value is changed into 2.15, 2.05, 1.95, or 1.90.

It is preferable to satisfy the inequality (12) in which the lower limit value is changed to 15.0. It is further preferable to satisfy the inequality (12) in which the lower limit values are changed to 17.0, 19.0, 20.0, or 21.0. It is preferable to satisfy the inequality (12) in which the upper limit value is changed to 45.0. It is further preferable to satisfy the inequality (12) in which the upper limit value is changed to 40.0, 35.0, 30.0, or 25.0.

The inequality (13) defines the ratio of a focal length of the lens second closest to the object in the first lens unit U1 to a focal length of the lens disposed closest to the object in the first lens unit U1. If the lower limit of the inequality (13) is not satisfied, the power of the lens closest to the object side in the first lens unit U1 is too weak, which makes it difficult to correct spherical aberration and axial chromatic aberration. If the upper limit of the inequality (13) is not satisfied, the refractive power of the lens disposed closest to the object side in the first lens unit U1 becomes too strong, which makes it difficult to correct spherical aberration and coma.

It is preferable to satisfy the inequality (13) in which the lower limit value is changed to 0.20. It is further preferable to satisfy the inequality (13) in which the lower limit value is changed to 0.25 or 0.30. It is preferable to satisfy the inequality (13) in which the upper limit value is changed to 1.30. It is further preferable to satisfy the inequality (13) in which the upper limit value is changed to 1.10, 0.90, 0.70, or 0.50.

The inequality (14) defines a shape factor of the curvature radius of the lens surface closest to the image side of the second lens unit U2 and the curvature radius of the lens surface closest to the object side of the third lens unit U3. If the lower limit of the inequality (14) is not satisfied, the curvature radius of the lens surface closest to the object side of the third lens unit U3 becomes too large, and thus the distance fluctuations in the curvature of field, the coma, and the chromatic aberration of magnification of the lens apparatus become large, which is not preferable. If the upper limit of the inequality (14) is not satisfied, the curvature radius of the lens surface closest to the image side of the second lens unit U2 becomes too large, and thus the distance fluctuations of the curvature of field, the coma, and the chromatic aberration of magnification of the lens apparatus become large, which is not preferable.

It is preferable to satisfy the inequality (14) in which the lower limit value is changed to 0.70. It is further preferable to satisfy the inequality (14) in which the lower limit value is changed to 0.80, 0.90, or 1.00. It is preferable to satisfy the inequality (14) in which the upper limit value is changed to 2.20. It is further preferable to satisfy the inequality (14) in which the upper limit value is changed to 2.00, 1.80, 1.70, or 1.60.

The inequality (15) and the inequality (16) define the Abbe number, and the partial dispersion ratio of the lens (third R negative lens) disposed closest to the image side in the third lens unit U3. If the lower limit of the inequality (15) is not satisfied, correction of chromatic aberration of magnification and curvature of field becomes difficult, which is not preferable. If the upper limit of the inequality (15) is not satisfied, chromatic aberration of magnification and curvature of field are excessively corrected, which is not preferable. If the lower limit of the inequality (16) is not satisfied, the chromatic aberration of magnification of the g-line is excessively corrected, which is not preferable. If the upper limit of the inequality (16) is not satisfied, the chromatic aberration of magnification of the g-line becomes insufficiently corrected, which is not preferable.

It is preferable to satisfy the inequality (15) in which the lower limit value is changed to 17.0. It is further preferable to satisfy the inequality (15) in which the lower limit value is changed into 20.0, 25.0, 27.0, or 30.0. It is preferable to satisfy the inequality (15) in which the upper limit value is changed to 80.0. It is further preferable to satisfy the inequality (15) in which the upper limit value is changed into 65.0, 60.0, 55.0, or 50.0.

It is preferable to satisfy the inequality (16) in which the lower limit value is changed to −0.002. It is further preferable to satisfy the inequality (16) in which the lower limit value is changed to 0.000, 0.002, or 0.003. It is preferable to satisfy the inequality (16) in which the upper limit value is changed to 0.015. It is further preferable to satisfy the inequality (16) in which the upper limit value is changed to 0.010, 0.008 or 0.007.

The inequality (17) and the inequality (18) define the Abbe number and the partial dispersion ratio of the lens (the third F negative lens) disposed at the second position closest to the image side in the third lens unit U3. If the lower limit of the inequality (17) is not satisfied, correction of chromatic aberration of magnification and curvature of field becomes difficult, which is not preferable. If the upper limit of the inequality (17) is not satisfied, the chromatic aberration of magnification and the curvature of field are excessively corrected, which is not preferable. If the lower limit of the inequality (18) is not satisfied, the chromatic aberration of magnification of the g-line is excessively corrected, which is not preferable. If the upper limit of the inequality (18) is not satisfied, the chromatic aberration of magnification of the g-line becomes insufficiently corrected, which is not preferable.

It is preferable to satisfy the inequality (17) in which the lower limit value is changed to 22.0. It is further preferable to satisfy the inequality (17) in which the lower limit value is changed to 25.0, 27.0, or 30.0. It is preferable to satisfy the inequality (17) in which the upper limit value is changed to 80.0. It is further preferable to satisfy the inequality (17) in which the upper limit value is changed to 65.0, 60.0, 55.0, or 50.0.

It is preferable to satisfy the inequality (18) in which the lower limit value is changed to −0.002. It is further preferable to satisfy the inequality (18) in which the lower limit value is changed to 0.000, 0.002, or 0.003. It is preferable to satisfy the inequality (18) in which the upper limit value is changed to 0.015. It is further preferable to satisfy the inequality (18) in which the upper limit value is changed to 0.010, 0.008, or 0.007.

The inequality (19) defines the radius of curvature having the smallest absolute value among the optical surfaces included in the first lens unit U1 and the third lens unit U3. In order to correct curvature of field and coma while reducing the number of lenses of the lens apparatus as much as possible, a surface having a strong curvature is necessary at a lens position where the height of off-axis light rays is high. If the lower limit of the inequality (19) is not satisfied, the radius of curvature becomes too small, and thus spherical aberration and axial chromatic aberration deteriorate, which is not preferable. If the upper limit of the inequality (19) is not satisfied, the curvature is too weak, so that curvature of field and coma are insufficiently corrected, which is not preferable.

It is preferable to satisfy the inequality (19) in which the lower limit value is changed to 0.23. It is further preferable to satisfy the inequality (19) in which the lower limit value is changed to 0.25, 0.26, 0.27, or 0.28. It is preferable to satisfy the inequality (19) in which the upper limit value is changed to 0.50. It is further preferable to satisfy the inequality (19) in which the upper limit value is changed to 0.45, 0.40, or 0.35.

The inequality (20) defines a variation in the angle of view from infinity to the closest distance in the lens apparatus. If the lower limit of the inequality (20) is not satisfied, there is a concern that the fluctuation of the angle of view may vibrate and become conspicuous during focusing, which is not preferable. If the lower limit of the inequality (20) is not satisfied, there is a high possibility that the user feels uncomfortable in changing the angle of view during focusing, which is not preferable.

It is preferable to satisfy the inequality (20) in which the lower limit value is changed to 1.0. It is further preferable to satisfy the inequality (20) in which the lower limit value is changed to 2.0 or 3.0. It is preferable to satisfy the inequality (20) in which the upper limit value is changed to 9.0. It is further preferable to satisfy the inequality (20) in which the upper limit value is changed to 8.0, 7.0, 6.0, or 5.0.

The inequality (21) defines an average value of the Abbe numbers of the negative lenses disposed in the first lens unit U1. If the lower limit of the inequality (21) is not satisfied, the dispersion per one negative lens becomes too strong, a large number of lenses are required to correct the dispersion, and the lens apparatus becomes large, which is not preferable. If the upper limit of the inequality (21) is not satisfied, the dispersion per negative lens is too weak to correct chromatic aberration, which is not preferable.

It is preferable to satisfy the inequality (21) in which the lower limit value is changed to 26.5. It is further preferable to satisfy the inequality (21) in which the lower limit value is changed to 27.0, 28.0, 28.5, or 29.0. It is preferable to satisfy the inequality (21) in which the upper limit value is changed to 55.0. It is further preferable to satisfy the inequality (21) in which the upper limit value is changed to 50.0, 45.0, 40.0 or 38.0.

The inequality (22) defines the refractive index of one of the negative lenses disposed in the first lens unit U1 and the refractive index of the negative lens disposed closer to the image side than the one of the negative lenses. The negative lens in the first lens unit U1 has a considerable influence on the axial chromatic aberration and the chromatic aberration of magnification, and needs to be configured in a balanced manner. In order to correct the axial chromatic aberration without adversely affecting the chromatic aberration of magnification, it is desirable to arrange the refractive index of the negative lens on the image side having a lower off-axis ray height to be equal to or higher than that of the negative lens on the object side. If the lower limit of the inequality (22) is not satisfied, chromatic aberration of magnification deteriorates, which is not preferable. If the upper limit of the inequality (22) is not satisfied, axial chromatic aberration deteriorates, which is not preferable.

It is preferable to satisfy the inequality (22) in which the lower limit value is changed to 0.92. It is further preferable to satisfy the inequality (22) in which the lower limit value is changed to 0.94, 0.96, 0.98, or 1.00. It is preferable to satisfy the inequality (22) in which that the upper limit value is changed to 1.25. It is further preferable to satisfy the inequality (22) in which the upper limit of the inequality (22) is changed to 1.20, 1.15, or 1.10.

The inequality (23) defines a relative movement amount of the second lens unit U2 with respect to the image plane during focusing from infinity to the closest distance. If the lower limit of the inequality (23) is not satisfied, the amount of movement of the second lens unit U2 during focusing becomes excessively large, and the lens apparatus becomes large, which is not preferable. If the upper limit of the inequality (23) is not satisfied, the power of the second lens unit U2 becomes too strong, and the performance fluctuation of spherical aberration and curvature of field with respect to the object distance of the lens apparatus becomes large, which is not preferable.

It is preferable to satisfy the inequality (23) in which the lower limit value is changed to −0.25. It is further preferable to satisfy the inequality (23) in which the lower limit value is changed to −0.22, −0.20, −0.17, −0.15, or −0.10. It is preferable that the upper limit of inequality (23) is changed to −0.05. It is further preferable to satisfy the inequality (23) in which the upper limit value is changed to −0.06 or −0.07.

The inequality (24) defines the F-number of the lens apparatus and the focal lengths of the second lens unit U2 and the third lens unit U3. If the lower limit of the inequality (24) is not satisfied, the focal length of the second lens unit U2 becomes too long, the amount of movement of the second lens unit U2 during focusing becomes large, and it becomes difficult to shorten the total lens length, which is not preferable. In addition, it is difficult to obtain a desired large aperture ratio, which is not preferable. If the upper limit of the inequality (24) is not satisfied, the power of the second lens unit U2 becomes too strong, and the performance fluctuations of spherical aberration and curvature of field with respect to the object distance of the lens apparatus become large, which is not preferable.

It is preferable to satisfy the inequality (24) in which the lower limit value is changed to −0.80. It is further preferable to satisfy the inequality (24) in which the lower limit value is changed to −0.70, −0.60, −0.55, or −0.50. It is preferable to satisfy the inequality (24) in which the upper limit value is changed to 0.20. It is further preferable to satisfy the inequality (24) in which the upper limit value is changed to 0.10, 0.05, 0.00, or −0.10.

The inequality (25) defines a partial dispersion ratio of the negative lens disposed in the second lens unit U2. If the lower limit of the inequality (25) is not satisfied, the chromatic aberration of the g-line is excessively corrected, which is not preferable. If the upper limit of the inequality (25) is not satisfied, the chromatic aberration of the g-line becomes insufficiently corrected, which is not preferable. The second lens unit U2 according to each embodiment of the disclosure includes two negative lenses L2n1 and L2n2 satisfying the inequality (25).

It is preferable to satisfy the inequality (25) in which the lower limit value is changed to −0.009. It is further preferable to satisfy the inequality (25) in which the lower limit value is changed to −0.008, −0.007, or −0.006. It is preferable to satisfy the inequality (25) in which the upper limit value is changed to −0.001. It is further preferable to satisfy the inequality (25) in which the upper limit value is changed to −0.002, −0.003, or −0.004.

The inequality (26) defines an imaging lateral magnification of the second lens unit U2 in the infinity focus state. If the lower limit of the inequality (26) is not satisfied, the power of the first lens unit U1 becomes too weak, so that spherical aberration and coma deteriorate, which is not preferable. If the upper limit of the inequality (26) is not satisfied, the power of the second lens unit U2 becomes too weak with respect to the first lens unit U1, and thus the amount of movement of the second lens unit U2 during focusing becomes too large to increase the size of the lens apparatus, which is not preferable.

It is preferable to satisfy the inequality (26) in which the lower limit value is changed to 0.25. It is further preferable to satisfy the inequality (26) in which the lower limit value is changed to 0.30, 0.32, or 0.34. It is preferable to satisfy the inequality (26) in which the upper limit value is changed to 0.65. It is further preferable to satisfy the inequality (26) in which the upper limit value is changed to 0.60, 0.55, 0.50, or 0.45.

The inequality (27) defines an imaging lateral magnification of the third lens unit U3 in the infinity focus state. If the lower limit of the inequality (27) is not satisfied, the power of the third lens unit U3 becomes too weak, so that curvature of field and chromatic aberration of magnification deteriorate, which is not preferable. If the upper limit of the inequality (27) is not satisfied, the power of the third lens unit U3 becomes too strong, and thus the performance fluctuations of spherical aberration and curvature of field with respect to the object distance of the lens apparatus become large, which is not preferable. In addition, the angle of incidence of light rays on the image plane becomes large, which is not preferable.

It is preferable to satisfy the inequality (27) in which the lower limit value is changed to 0.80. It is further preferable to satisfy the inequality (27) in which the lower limit of the inequality (27) is changed to 0.90, 1.00, or 1.10. It is preferable to satisfy the inequality (27) in which the upper limit value is changed to 1.50. It is further preferable to satisfy the inequality (27) in which the upper limit of the inequality (27) is changed to 1.45, 1.40, or 1.35.

The inequality (28) defines an imaging lateral magnification when the second lens unit U2 and the third lens unit U3 are in the infinity focus state. If the lower limit of the inequality (28) is not satisfied, the amount of movement of the second lens unit U2 during focusing increases, which makes it difficult to shorten the total lens length, which is not preferable. If the upper limit of the inequality (28) is not satisfied, performance fluctuations of spherical aberration and curvature of field with respect to the object distance of the lens apparatus become large, which is not preferable.

It is preferable to satisfy the inequality (28) in which the lower limit value is changed to 0.50. It is further preferable to satisfy the inequality (28) in which the lower limit of the inequality (28) is changed to 0.60, 0.70, or 0.80. It is preferable to satisfy the inequality (28) in which the upper limit value is changed to 1.90. It is more preferable to satisfy the inequality (28) in which the upper limit value is changed to 1.80, 1.70, 1.60, or 1.50.

The inequality (29) defines the ratio of the focal length of the first lens unit U1 to the back focus of the lens apparatus. If the lower limit of the inequality (29) is not satisfied, spherical aberration and coma deteriorate, which is not preferable. If the upper limit of the inequality (29) is not satisfied, correction of chromatic aberration of magnification becomes difficult, which is not preferable.

It is preferable to satisfy the inequality (29) in which the lower limit value is changed to 6.00. It is further preferable to satisfy the inequality (29) in which the lower limit value is changed to 7.00, 8.00, or 9.00. It is preferable to satisfy the inequality (29) in which the upper limit value is changed to 27.00. It is further preferable to satisfy the inequality (29) in which the upper limit value is changed to 25.00, 23.00, 20.00, or 18.00.

The inequality (30) defines the ratio of the focal length of the second lens unit U2 to the back focus of the lens apparatus. If the lower limit of the inequality (30) is not satisfied, correction of curvature of field and coma becomes difficult, which is not preferable. If the upper limit of the inequality (30) is not satisfied, the amount of movement of the second lens unit U2 during focusing becomes too large and the lens apparatus becomes large, which is not preferable.

It is preferable to satisfy the inequality (30) in which the lower limit value is changed to 1.30. It is further preferable to satisfy the inequality (30) in which the lower limit value is changed to 1.50, 1.70, 1.90, or 2.00. It is preferable to satisfy the inequality (30) in which the upper limit value is changed to 8.00. It is further preferable to satisfy the inequality (30) in which the upper limit value is changed to 7.00, 6.00, or 5.00.

The inequality (31) defines the ratio of the back focus of the lens apparatus to the focal length of the third lens unit U3. If the lower limit of the inequality (31) is not satisfied, performance fluctuations of spherical aberration and curvature of field become large, which is not preferable. In addition, the angle of incidence of beams on the image plane becomes large, which is not preferable. If the upper limit of the inequality (31) is not satisfied, curvature of field and chromatic aberration of magnification deteriorate, which is not preferable.

It is preferable to satisfy the inequality (31) in which the lower limit value is changed to −0.25. It is further preferable to satisfy the inequality (31) in which the lower limit value is changed to −0.20, −0.17, or −0.15. It is preferable to satisfy the inequality (31) in which the upper limit value is changed to 0.08. It is further preferable to satisfy the inequality (31) in which the upper limit value is changed to 0.06, 0.04, 0.02, or 0.00.

The inequality (32) defines the ratio of the distance on the optical axis from the surface of the first lens unit U1 closest to the image side to the surface of the second lens unit U2 closest to the object side relative to the focal length of the lens apparatus. If the lower limit of the inequality (32) is not satisfied, the power of the second lens unit U2 becomes too strong, and the performance fluctuation of spherical aberration and curvature of field with respect to the object distance of the lens apparatus becomes large, which is not preferable. If the upper limit of the inequality (32) is not satisfied, the amount of movement of the second lens unit U2 during focusing becomes excessively large, and the lens apparatus becomes large, which is not preferable.

It is preferable to satisfy the inequality (32) in which the lower limit value is changed to 0.22. It is further preferable to satisfy the inequality (32) in which the lower limit value is changed to 0.24 or 0.26. It is preferable to satisfy the inequality (32) in which the upper limit value is changed to 0.45. It is more preferable to satisfy the inequality (32) in which the upper limit value is changed to 0.40, 0.35, or 0.32.

The inequality (33) defines the ratio of the combined focal length of the lenses disposed in the object side of the aperture stop of the lens apparatus to the focal length of the lens apparatus. If the lower limit of the inequality (33) is not satisfied, the power of the lenses in the object side of the aperture stop becomes too strong, and the spherical aberration and the chromatic aberration of magnification deteriorate, which is not preferable. If the upper limit of the inequality (33) is not satisfied, the power of the lenses in the object side of the aperture stop is too weak, so that curvature of field and axial chromatic aberration are deteriorated, which is not preferable.

It is preferable to satisfy the inequality (33) in which the lower limit value is changed to 1.40. It is further preferable to satisfy the inequality (33) in which the lower limit value is changed to 1.60, 1.80, or 2.00. It is preferable to satisfy the inequality (33) in which the upper limit value is changed to 4.50. It is further preferable to satisfy the inequality (33) in which the upper limit value is changed to 4.20, 3.80, 3.40, or 3.00.

The inequality (34) defines the ratio of the combined focal length of the lenses disposed in the image side of the aperture stop of the lens apparatus to the focal length of the lens apparatus. If the lower limit of the inequality (34) is not satisfied, the power of the lenses in the image side of the aperture stop becomes too strong, and the curvature of field and the coma deteriorate, which is not preferable. If the upper limit of the inequality (34) is not satisfied, the power of the lenses in the image side of the aperture stop is too weak, and the curvature of field and the chromatic aberration of magnification deteriorate, which is not preferable.

It is preferable to satisfy the inequality (34) in which the lower limit value is changed to 0.60. It is further preferable to satisfy the inequality (34) in which the lower limit value is changed to 0.65 or 0.70. It is preferable to satisfy the inequality (34) in which the upper limit value is changed to 1.00. It is further preferable to satisfy the inequality (34) in which the upper limit value is changed to 0.95, 0.90, 0.88, or 0.86.

The inequality (35) defines the ratio of the combined focal length of the lenses disposed in the object side of the aperture stop of the lens apparatus to the combined focal length of the lenses disposed in the object side of the aperture stop of the lens apparatus. If the lower limit of the inequality (35) is not satisfied, the power of the lenses in the image side of the aperture stop becomes too strong, and the curvature of field and the coma deteriorate, which is not preferable. If the upper limit of the inequality (35) is not satisfied, the power of the lenses in the object side of the aperture stop becomes too strong, and the spherical aberration and the chromatic aberration of magnification deteriorate, which is not preferable.

It is preferable to satisfy the inequality (35) in which the lower limit value is changed to 0.15. It is further preferable to satisfy the inequality (35) in which the lower limit value is changed to 0.20, 0.25, or 0.30. It is preferable to satisfy the inequality (35) in which the upper limit of the inequality (35) is changed to 0.70. It is further preferable to satisfy the inequality (35) in which the upper limit value is changed to 0.60, 0.50, or 0.45.

Hereinafter, numerical embodiments 1 to 14 corresponding to embodiments 1 to 14, respectively, will be described.

In the surface data of each numerical embodiment, r represents the radius of curvature of each optical surface, and d (mm) represents the axial distance (distance on the optical axis) between the m-th surface and the (m+1)-th surface. Here, m is the number of the surface counted from the light incident side. In addition, nd represents the refractive index of each optical member with respect to the d-line, and vd represents the Abbe number of the optical member. It should be noted that the Abbe number vd of a material is represented by

$$v d = ( N d - 1 ) / ( N F - N C )$$

where Nd, NF and NC represent refractive indices for d-line (587.6 nm), F-line (486.1 nm) and C-line (656.3 nm) of Fraunhofer line, respectively.

In addition, θgF represents a partial dispersion ratio of each optical member with respect to the g-line, and the partial dispersion ratio θgF of a certain material is represented by

$$θgF = ( Ng - NF ) / ( NF - NC )$$

where NF, NC, and Ng represent refractive indexes for F-line (486.1 nm), C-line (656.3 nm) and g-line (435.8 nm) of the Fraunhofer line, respectively.

In each numerical embodiment, d, focal length (mm), F-number, and half angle of view (degrees) are all values of the lens apparatus of each embodiment in the infinity focused state. The back focus BF represents the distance on the optical axis from the last lens surface (the lens surface closest to the image side) to the paraxial image plane in terms of air conversion length. The total lens length is a length obtained by adding the back focus to the distance on the optical axis from the first lens surface (the lens surface closest to the object side) to the final lens surface. The lens unit is not limited to being composed of a plurality of lenses and may be composed of one lens.

When an optical surface is an aspherical surface, the right side of the surface number is denoted by “*”. An aspherical shape is represented by

$$x = \frac{\frac{{h}^{2}}{r}}{1 + \sqrt{1 - ( 1 + K ) {( \frac{h}{r} )}^{2}}} + A 4 \cdot {h}^{4} + A 6 \cdot {h}^{6} + A 8 \cdot {h}^{8} + A 10 \cdot {h}^{10} + A 12 \cdot {h}^{12}$$

where x represents the amount of displacement from the vertex of the surface in the optical axis direction, h represents the height from the optical axis in the direction perpendicular to the optical axis, r represents paraxial radius of curvature, K represents a conic constant, and A4, A6, A8, A10 and A12 are aspherical coefficients of each order. Note that “e±XX” in each aspherical coefficient means “×10^{±XX}”

[Numerical embodiment 1]
Unit mm
Surface data

| Surface | | | | | |
|---|---|---|---|---|---|
| number | r | d | nd | vd | θgF |
| 1 | 85.711 | 4.40 | 1.80810 | 22.8 | |
| 2 | 172.688 | 0.30 | | | |
| 3 | 44.670 | 9.22 | 1.59522 | 67.7 | |
| 4 | 185.421 | 0.65 | | | |
| 5 | 34.802 | 8.81 | 1.53775 | 74.7 | |
| 6 | 145.052 | 1.60 | 1.77047 | 29.7 | 0.5951 |
| 7 | 25.075 | 7.82 | | | |
| 8 | 509.541 | 1.40 | 1.77047 | 29.7 | 0.5951 |
| 9 | 99.203 | 5.72 | | | |
| 10(stop) | ∞ | (variable) | | | |
| 11 | −31.665 | 0.90 | 1.61340 | 44.3 | 0.5633 |
| 12 | 727.029 | 0.15 | | | |
| 13* | 82.051 | 6.15 | 1.80400 | 46.5 | |
| 14* | −74.067 | 1.39 | | | |
| 15 | 201.950 | 1.08 | 1.65412 | 39.7 | 0.5737 |
| 16 | 40.155 | 9.43 | 1.59522 | 67.7 | |
| 17 | −37.387 | (variable) | | | |
| 18 | 1492.403 | 1.20 | 1.72825 | 28.5 | |
| 19 | 44.650 | 4.86 | | | |
| 20 | 53.987 | 9.15 | 2.00100 | 29.1 | |
| 21 | −55.940 | 1.30 | 1.53172 | 48.8 | 0.5631 |
| 22 | 71.526 | 6.48 | | | |
| 23 | −51.974 | 1.30 | 1.63980 | 34.5 | 0.5922 |
| 24 | −266.753 | 14.91 | | | |
| Image plane | ∞ | | | | |

Aspherical data
The thirteenth surface
K = 0.00000e+00 A 4 = −3.93536e−06 A 6 = 2.19775e−09
A 8 = −9.74527e−11 A10 = 3.31019e−13 A12 = −8.98526e−16
The fourteenth surface
K = 0.00000e+00 A 4 = 2.66866e−06 A 6 = 1.89399e−09
A 8 = −7.26017e−11 A10 = 2.14452e−13 A12 = −5.95719e−16

Various data

| | |
|---|---|
| Focal length | 82.60 |
| F-number | 1.44 |
| Half angle of view | 14.68 |
| Image height | 21.63 |
| Total lens length | 117.52 |
| BF | 14.91 |

| | Infinity | Closest distance |
|---|---|---|
| d10 | 16.44 | 6.97 |
| d17 | 2.87 | 12.34 |

Lens unit data

| Unit | Leading surface | Focal length |
|---|---|---|
| 1 | 1 | 196.15 |
| 2 | 11 | 51.80 |
| 3 | 18 | −208.88 |

[Numerical embodiment 2]
Unit mm
Surface data

| Surface | | | | | |
|---|---|---|---|---|---|
| number | r | d | nd | vd | θgF |
| 1 | 81.194 | 4.07 | 1.84666 | 23.9 | |
| 2 | 152.711 | 0.30 | | | |
| 3 | 44.431 | 8.93 | 1.59522 | 67.7 | |
| 4 | 160.167 | 0.65 | | | |
| 5 | 33.692 | 8.85 | 1.53775 | 74.7 | 0.5951 |
| 6 | 120.211 | 1.60 | 1.77047 | 29.7 | |
| 7 | 24.283 | 7.76 | | | |
| 8 | 233.117 | 1.30 | 1.73037 | 32.2 | 0.5899 |
| 9 | 79.764 | 6.10 | | | |
| 10(stop) | ∞ | (variable) | | | |
| 11 | −30.458 | 1.00 | 1.61340 | 44.3 | 0.5633 |
| 12 | 240.098 | 0.15 | | | |
| 13* | 61.413 | 6.24 | 1.80400 | 46.5 | |
| 14* | −62.069 | 0.20 | | | |
| 15 | 199.660 | 1.10 | 1.61340 | 44.3 | 0.5633 |
| 16 | 30.426 | 11.19 | 1.53775 | 74.7 | |
| 17 | −38.364 | (variable) | | | |
| 18 | 1354.179 | 1.20 | 1.69895 | 30.1 | |
| 19 | 41.062 | 3.71 | | | |
| 20 | 52.689 | 9.61 | 2.00100 | 29.1 | |
| 21 | −49.669 | 1.30 | 1.60342 | 38.0 | 0.5835 |
| 22 | 80.999 | 6.18 | | | |
| 23 | −50.699 | 1.30 | 1.51742 | 52.4 | 0.5564 |
| 24 | −266.891 | 14.91 | | | |
| Image plane | ∞ | | | | |

Aspherical data
The thirteenth surface
K = 0.00000e+00 A 4 = −3.14948e−06 A 6 = 9.81747e−09
A 8 = −7.25479e−11 A10 = 3.07580e−13 A12 = −6.00601e−16
The fourteenth surface
K = 0.00000e+00 A 4 = 3.47313e−06 A 6 = 8.71345e−09
A 8 = −6.46786e−11 A10 = 2.90427e−13 A12 = −5.77646e−16

Various data

| | |
|---|---|
| Focal length | 82.50 |
| F-number | 1.44 |
| Half angle of view | 14.69 |
| Image height | 21.63 |
| Total lens length | 117.52 |
| BF | 14.91 |

| | Infinity | Closest distance |
|---|---|---|
| d10 | 17.00 | 7.20 |
| d17 | 2.87 | 12.67 |

Lens unit data

| Unit | Leading surface | Focal length |
|---|---|---|
| 1 | 1 | 197.46 |
| 2 | 11 | 52.89 |
| 3 | 18 | −249.47 |

[Numerical embodiment 3]
Unit mm
Surface data

| Surface | | | | | |
|---|---|---|---|---|---|
| number | r | d | nd | vd | θgF |
| 1 | 69.299 | 3.94 | 2.00069 | 25.5 | |
| 2 | 113.756 | 0.20 | | | |
| 3 | 50.101 | 8.86 | 1.59522 | 67.7 | |
| 4 | 208.028 | 0.50 | | | |
| 5 | 35.512 | 9.48 | 1.59522 | 67.7 | |
| 6 | 287.548 | 1.60 | 1.77047 | 29.7 | 0.5951 |
| 7 | 24.506 | 7.55 | | | |
| 8 | 1586.902 | 1.30 | 1.77047 | 29.7 | 0.5951 |
| 9 | 111.660 | 4.07 | | | |
| 10(stop) | ∞ | (variable) | | | |
| 11 | −36.005 | 0.90 | 1.61340 | 44.3 | 0.5633 |
| 12 | 164.100 | 0.14 | | | |
| 13* | 65.349 | 6.70 | 1.80400 | 46.5 | |
| 14* | −49.373 | 6.98 | | | |
| 15 | −86.621 | 1.10 | 1.77047 | 29.7 | 0.5951 |
| 16 | 1520.575 | 4.84 | 1.75500 | 52.3 | |
| 17 | −48.619 | (variable) | | | |
| 18 | −195.078 | 5.56 | 1.91082 | 35.2 | |
| 19 | −35.528 | 1.20 | 1.77047 | 29.7 | |
| 20 | 68.963 | 0.77 | | | |
| 21 | 53.101 | 9.64 | 2.00100 | 29.1 | |
| 22 | −98.826 | 1.30 | 1.51823 | 58.9 | 0.5457 |
| 23 | 81.466 | 7.39 | | | |
| 24 | −41.851 | 1.30 | 1.80810 | 22.8 | 0.6307 |
| 25 | −58.162 | 12.00 | | | |
| image plane | ∞ | | | | |

Aspherical data
The thirteenth surface
K = 0.00000e+00 A 4 = −3.10221e−06 A 6 = 3.31924e−09
A 8 = −3.36661e−11 A10 = 1.62125e−13 A12 = −4.65124e−16
The fourteenth surface
K = 0.00000e+00 A 4 = 1.89421e−06 A 6 = 3.29200e−09
A 8 = −4.13312e−11 A10 = 2.01462e−13 A12 = −5.18869e−16

Various data

| | |
|---|---|
| Focal length | 82.50 |
| F-number | 1.46 |
| Half angle of view | 14.69 |
| Image height | 21.63 |
| Total lens length | 118.00 |
| BF | 12.00 |

| | Infinity | Closest distance |
|---|---|---|
| d10 | 18.68 | 4.82 |
| d17 | 2.00 | 15.86 |

Lens unit data

| Unit | Leading surface | Focal length |
|---|---|---|
| 1 | 1 | 192.35 |
| 2 | 11 | 65.97 |
| 3 | 18 | 1035.38 |

[Numerical embodiment 4]
Unit mm
Surface data

| Surface | | | | | |
|---|---|---|---|---|---|
| number | r | d | nd | vd | θgF |
| 1 | 78.427 | 4.11 | 2.00069 | 25.5 | |
| 2 | 154.526 | 0.20 | | | |
| 3 | 47.936 | 5.83 | 1.59522 | 67.7 | |
| 4 | 94.373 | 0.50 | | | |
| 5 | 34.874 | 8.90 | 1.59522 | 67.7 | |
| 6 | 110.225 | 0.20 | | | |
| 7 | 85.587 | 1.60 | 1.77047 | 29.7 | 0.5951 |
| 8 | 25.121 | 7.76 | | | |
| 9 | 223.708 | 4.21 | 1.59522 | 67.7 | |
| 10 | −77.386 | 1.40 | 1.73037 | 32.2 | 0.5899 |
| 11 | 118.661 | 5.20 | | | |
| 12(stop) | ∞ | (variable) | | | |
| 13 | −35.065 | 0.90 | 1.61340 | 44.3 | 0.5633 |
| 14 | 172.897 | 0.13 | | | |
| 15* | 67.168 | 6.07 | 1.80400 | 46.5 | |
| 16* | −44.994 | 5.99 | | | |
| 17 | −50.359 | 1.10 | 1.73037 | 32.2 | 0.5899 |
| 18 | 832.048 | 5.87 | 1.76385 | 48.5 | |
| 19 | −37.205 | (variable) | | | |
| 20 | −436.679 | 4.18 | 1.95375 | 32.3 | |
| 21 | −50.983 | 1.20 | 1.77047 | 29.7 | |
| 22 | 49.016 | 1.65 | | | |
| 23 | 47.967 | 7.74 | 2.00100 | 29.1 | |
| 24 | −109.101 | 1.30 | 1.51742 | 52.4 | 0.5564 |
| 25 | 70.346 | 6.57 | | | |
| 26 | −53.358 | 1.30 | 1.72825 | 28.5 | 0.6077 |
| 27 | −91.583 | 11.99 | | | |
| image plane | ∞ | | | | |

Aspherical data
The fifteenth surface
K = 0.00000e+00 A 4 = −2.5513le−06 A 6 = −1.87066e−09
A 8 = 3.40325e−11 A10 = −1.35512e−13 A12 = 1.89277e−16
The sixteenth surface
K = 0.00000e+00 A 4 = 3.91899e−06 A 6 = 3.95520e−10
A 8 = 2.90779e−12 A10 = 3.38547e−14 A12 = −1.11455e−16

Various data

| | |
|---|---|
| Focal length | 82.49 |
| F-number | 1.46 |
| Half angle of view | 14.70 |
| Image height | 21.63 |
| Total lens length | 117.51 |
| BF | 11.99 |

| | Infinity | Closest distance |
|---|---|---|
| d12 | 19.62 | 6.18 |
| d19 | 1.99 | 15.43 |

Lens unit data

| Unit | Leading Focal | surface length |
|---|---|---|
| 1 | 1 | 167.45 |
| 2 | 13 | 62.40 |
| 3 | 20 | −842.30 |

[Numerical embodiment 5]
Unit mm
Surface data

| Surface | | | | | |
|---|---|---|---|---|---|
| number | r | d | nd | vd | θgF |
| 1 | 75.809 | 4.02 | 1.84666 | 23.9 | |
| 2 | 134.138 | 0.20 | | | |
| 3 | 44.068 | 9.29 | 1.59522 | 67.7 | |
| 4 | 178.758 | 1.05 | | | |
| 5 | 37.480 | 9.17 | 1.49700 | 81.7 | |
| 6 | 172.898 | 1.50 | 1.77047 | 29.7 | 0.5951 |
| 7 | 40.094 | 1.60 | | | |
| 8 | 56.794 | 1.30 | 1.77047 | 29.7 | 0.5951 |
| 9 | 26.318 | 8.98 | | | |
| 10(stop) | ∞ | (variable) | | | |
| 11 | −32.079 | 1.00 | 1.61340 | 44.3 | 0.5633 |
| 12 | 141.594 | 0.20 | | | |
| 13* | 51.492 | 6.85 | 1.80400 | 46.5 | |
| 14* | −64.720 | 0.15 | | | |
| 15 | 486.843 | 1.00 | 1.61340 | 44.3 | 0.5633 |
| 16 | 31.191 | 9.27 | 1.59522 | 67.7 | |
| 17 | −42.739 | (variable) | | | |
| 18 | −505.803 | 1.10 | 1.72342 | 38.0 | |
| 19 | 25.457 | 5.38 | 1.48749 | 70.2 | |
| 20 | 45.433 | 2.92 | | | |
| 21 | 54.147 | 10.65 | 2.00100 | 29.1 | |
| 22 | −36.894 | 1.20 | 1.59270 | 35.3 | 0.5933 |
| 23 | 105.461 | 5.80 | | | |
| 24 | −47.150 | 1.30 | 1.59270 | 35.3 | 0.5933 |
| 25 | −160.992 | 15.09 | | | |
| image plane | ∞ | | | | |

Aspherical data
The thirteenth surface
K = 0.00000e+00 A 4 = −4.34414e−06 A 6 = 7.63666e−09
A 8 = −7.45046e−11 A10 = 3.32786e−13 A12 = −7.64837e−16
The fourteenth surface
K = 0.00000e+00 A 4 = 2.97381e−06 A 6 = 6.88577e−09
A 8 = −6.70959e−11 A10 = 3.09798e−13 A12 = −7.23048e−16

Various data

| | |
|---|---|
| Focal length | 82.50 |
| F-number | 1.46 |
| Half angle of view | 14.69 |
| Image height | 21.63 |
| Total lens length | 117.10 |
| BF | 15.09 |

| | Infinity | Closest distance |
|---|---|---|
| d10 | 15.98 | 7.54 |
| d17 | 2.10 | 10.54 |

Lens unit data

| Unit | Leading surface | Focal length |
|---|---|---|
| 1 | 1 | 189.25 |
| 2 | 11 | 49.83 |
| 3 | 18 | −203.98 |

[Numerical embodiment 6]
Unit mm
Surface data

| Surface | | | | | |
|---|---|---|---|---|---|
| number | r | d | nd | vd | θgF |
| 1 | 97.228 | 3.17 | 1.80810 | 22.8 | |
| 2 | 168.826 | 0.20 | | | |
| 3 | 41.379 | 10.84 | 1.59282 | 68.6 | |
| 4 | 200.784 | 1.00 | | | |
| 5 | 40.219 | 8.03 | 1.53775 | 74.7 | |
| 6 | 198.669 | 1.50 | 1.66565 | 35.6 | 0.5820 |
| 7 | 49.362 | 1.90 | | | |
| 8 | 84.177 | 1.30 | 1.77047 | 29.7 | 0.5951 |
| 9 | 27.576 | 10.15 | | | |
| 10(stop) | ∞ | (variable) | | | |
| 11 | −31.134 | 1.29 | 1.61340 | 44.3 | 0.5633 |
| 12 | 96.564 | 0.25 | | | |
| 13* | 49.942 | 8.35 | 1.80400 | 46.5 | |
| 14* | −64.735 | 1.22 | | | |
| 15 | 117.139 | 1.00 | 1.62205 | 41.1 | 0.5690 |
| 16 | 54.207 | 7.32 | 1.59282 | 68.6 | |
| 17 | −39.455 | (variable) | | | |
| 18 | −166.269 | 1.10 | 1.76634 | 35.8 | |
| 19 | 24.940 | 5.44 | 1.49700 | 81.7 | |
| 20 | 43.276 | 3.66 | | | |
| 21 | 61.692 | 12.72 | 2.00100 | 29.1 | |
| 22 | −31.249 | 1.20 | 1.59270 | 35.3 | 0.5933 |
| 23 | 219.792 | 4.40 | | | |
| 24 | −52.388 | 1.30 | 1.59270 | 35.3 | 0.5933 |
| 25 | −865.095 | 14.89 | | | |
| image plane | ∞ | | | | |

Aspherical data
The thirteenth surface
K = 0.00000e+00 A 4 = −4.83963e−06 A 6 = 8.39015e−10
A 8 = −4.48994e−11 A10 = 2.4233le−13 A12 = −6.32257e−16
The fourteenth surface
K = 0.00000e+00 A 4 = 4.38692e−06 A 6 = 2.60397e−09
A 8 = −4.57563e−11 A10 = 2.44643e−13 A12 = −5.88968e−16

Various data

| | |
|---|---|
| Focal length | 83.05 |
| F-number | 1.46 |
| Half angle of view | 14.60 |
| Image height | 21.63 |
| Total lens length | 118.14 |
| BF | 14.89 |

| | Infinity | Closest distance |
|---|---|---|
| d10 | 13.76 | 7.44 |
| d17 | 2.15 | 8.47 |

Lens unit data

| Unit | Leading surface | Focal length |
|---|---|---|
| 1 | 1 | 168.72 |
| 2 | 11 | 41.81 |
| 3 | 18 | −113.14 |

[Numerical embodiment 7]
Unit mm
Surface data

| Surface | | | | | |
|---|---|---|---|---|---|
| number | r | d | nd | vd | θgF |
| 1 | 96.026 | 5.00 | 1.90366 | 31.3 | |
| 2 | 168.366 | 4.54 | | | |
| 3 | 45.025 | 14.83 | 1.57144 | 71.6 | |
| 4 | 209.436 | 1.34 | | | |
| 5 | 40.362 | 7.92 | 1.49700 | 81.7 | |
| 6 | 189.800 | 2.90 | 1.67300 | 38.3 | 0.5757 |
| 7 | 59.902 | 1.61 | | | |
| 8 | 95.509 | 1.30 | 1.77047 | 29.7 | 0.5951 |
| 9 | 26.901 | 9.89 | | | |
| 10(stop) | ∞ | (variable) | | | |
| 11 | −30.768 | 1.00 | 1.61340 | 44.3 | 0.5633 |
| 12 | 111.087 | 0.20 | | | |
| 13* | 51.970 | 7.23 | 1.80400 | 46.5 | |
| 14* | −68.052 | 0.15 | | | |
| 15 | 132.562 | 1.10 | 1.66565 | 35.6 | 0.5820 |
| 16 | 36.038 | 8.42 | 1.59522 | 67.7 | |
| 17 | −41.053 | (variable) | | | |
| 18 | −201.329 | 1.10 | 1.80420 | 46.5 | |
| 19 | 26.394 | 5.76 | 1.48749 | 70.2 | |
| 20 | 52.618 | 3.17 | | | |
| 21 | 59.558 | 11.04 | 2.00100 | 29.1 | |
| 22 | −34.464 | 1.20 | 1.59270 | 35.3 | 0.5933 |
| 23 | 176.938 | 4.69 | | | |
| 24 | −50.588 | 1.30 | 1.59270 | 35.3 | 0.5933 |
| 25 | −258.856 | 14.86 | | | |
| image plane | ∞ | | | | |

Aspherical data
The thirteenth surface
K = 0.00000e+00 A 4 = −3.20525e−06 A 6 = 9.04389e−10
A 8 = −4.69907e−11 A10 = 2.62624e−13 A12 = −6.22599e−16
The fourteenth surface
K = 0.00000e+00 A 4 = 3.84427e−06 A 6 = 1.52484e−09
A 8 = −3.24113e−11 A10 = 1.89133e−13 A12 = −4.88668e−16

Various data

| | |
|---|---|
| Focal length | 98.20 |
| F-number | 1.46 |
| Half angle of view | 12.42 |
| Image height | 21.63 |
| Total lens length | 130.02 |
| BF | 14.86 |

| | Infinity | Closest distance |
|---|---|---|
| d10 | 17.33 | 7.46 |
| d17 | 2.15 | 12.02 |

Lens unit data

| Unit | Leading surface | Focal length |
|---|---|---|
| 1 | 1 | 170.96 |
| 2 | 11 | 48.24 |
| 3 | 18 | −133.88 |

[Numerical embodiment 8]
Unit mm
Surface data

| Surface | | | | | |
|---|---|---|---|---|---|
| number | r | d | nd | vd | θgF |
| 1 | 99.589 | 3.47 | 1.84666 | 23.9 | |
| 2 | 173.493 | 0.20 | | | |
| 3 | 42.371 | 10.54 | 1.59522 | 67.7 | |
| 4 | 210.582 | 1.06 | | | |
| 5 | 38.837 | 8.09 | 1.49700 | 81.7 | |
| 6 | 159.379 | 2.57 | 1.66565 | 35.6 | 0.5820 |
| 7 | 50.805 | 1.73 | | | |
| 8 | 85.565 | 1.30 | 1.77047 | 29.7 | 0.5951 |
| 9 | 26.613 | 8.89 | | | |
| 10(stop) | ∞ | (variable) | | | |
| 11 | −30.290 | 1.00 | 1.61340 | 44.3 | 0.5633 |
| 12 | 104.164 | 0.20 | | | |
| 13* | 51.450 | 7.34 | 1.80400 | 46.5 | |
| 14* | −63.581 | 0.15 | | | |
| 15 | 115.144 | 1.30 | 1.66565 | 35.6 | 0.5820 |
| 16 | 43.099 | 8.39 | 1.59522 | 67.7 | |
| 17 | −39.969 | (variable) | | | |
| 18 | −252.835 | 1.10 | 1.76200 | 40.1 | |
| 19 | 24.975 | 5.80 | 1.49700 | 81.7 | |
| 20 | 46.998 | 3.67 | | | |
| 21 | 60.576 | 11.06 | 2.00100 | 29.1 | |
| 22 | −33.415 | 1.20 | 1.59270 | 35.3 | 0.5933 |
| 23 | 166.902 | 4.82 | | | |
| 24 | −48.682 | 1.30 | 1.59270 | 35.3 | 0.5933 |
| 25 | −357.203 | 14.91 | | | |
| image plane | ∞ | | | | |

Aspherical data
The thirteenth surface
K = 0.00000e+00 A 4 = −4.71780e−06 A 6 = 2.46819e−09
A 8 = −5.65390e−11 A10 = 3.01258e−13 A12 = −8.38261e−16
The fourteenth surface
K = 0.00000e+00 A 4 = 3.63620e−06 A 6 = 2.86896e−09
A 8 = −4.45355e−11 A10 = 2.45324e−13 A12 = −7.05135e−16

Various data

| | |
|---|---|
| Focal length | 83.14 |
| F-number | 1.46 |
| Half angle of view | 14.58 |
| Image height | 21.63 |
| Total lens length | 116.76 |
| BF | 14.91 |

| | Infinity | Closest distance |
|---|---|---|
| d10 | 14.52 | 7.52 |
| d17 | 2.15 | 9.15 |

Lens unit data

| Unit | Leading surface | Focal length |
|---|---|---|
| 1 | 1 | 175.86 |
| 2 | 11 | 44.29 |
| 3 | 18 | −129.57 |

[Numerical embodiment 9]
Unit mm
Surface data

| Surface | | | | | |
|---|---|---|---|---|---|
| number | r | d | nd | vd | θgF |
| 1 | 67.105 | 3.46 | 1.92286 | 20.9 | |
| 2 | 116.947 | 0.10 | | | |
| 3 | 55.455 | 5.74 | 1.59522 | 67.7 | |
| 4 | 176.537 | 9.98 | | | |
| 5 | 445.843 | 1.26 | 1.73037 | 32.2 | 0.5899 |
| 6 | 80.483 | 3.55 | 1.59522 | 67.7 | |
| 7 | 1051.320 | 0.10 | | | |
| 8 | 107.455 | 1.16 | 1.77047 | 29.7 | 0.5951 |
| 9 | 23.696 | 7.05 | 1.57144 | 71.6 | |
| 10 | 65.102 | 4.95 | | | |
| 11(stop) | ∞ | (variable) | | | |
| 12 | −35.560 | 0.90 | 1.61340 | 44.3 | 0.5633 |
| 13 | 131.508 | 0.15 | | | |
| 14 | 54.776 | 6.01 | 1.88300 | 40.8 | |
| 15 | −54.060 | 2.40 | | | |
| 16 | −52.643 | 1.00 | 1.73037 | 32.2 | 0.5899 |
| 17 | 64.403 | 1.17 | | | |
| 18* | 59.603 | 6.64 | 1.80400 | 46.5 | |
| 19* | −54.841 | (variable) | | | |
| 20 | −247.709 | 5.76 | 1.61997 | 63.9 | |
| 21 | −32.116 | 1.20 | 1.59270 | 35.3 | |
| 22 | 49.936 | 2.84 | | | |
| 23 | 61.515 | 9.92 | 2.05090 | 26.9 | |
| 24 | −47.578 | 1.30 | 1.59270 | 35.3 | 0.5933 |
| 25 | 94.429 | 7.85 | | | |
| 26 | −35.088 | 1.30 | 1.59270 | 35.3 | 0.5933 |
| 27 | −68.429 | 12.22 | | | |
| image plane | ∞ | | | | |

Aspherical data
The eighteenth surface
K = 0.00000e+00 A 4 = −2.81841e−06 A 6 = −2.49797e−09
A 8 = 1.54912e−11 A10 = −5.66952e−14
The nineteenth surface
K = 0.00000e+00 A 4 = 2.47387e−06 A 6 = −3.48143e−09
A 8 = 2.29005e−11 A10 = −6.83295e−14

Various data

| | |
|---|---|
| Focal length | 75.00 |
| F-number | 1.46 |
| Half angle of view | 16.09 |
| Image height | 21.63 |
| Total lens length | 118.20 |
| BF | 12.22 |

| | Infinity | Closest distance |
|---|---|---|
| d11 | 18.21 | 6.16 |
| d19 | 2.00 | 14.05 |

Lens unit data

| Unit | Leading surface | Focal length |
|---|---|---|
| 1 | 1 | 159.10 |
| 2 | 12 | 68.21 |
| 3 | 20 | −1331327.58 |

[Numerical embodiment 10]
Unit mm
Surface data

| Surface | | | | | |
|---|---|---|---|---|---|
| number | r | d | nd | vd | θgF |
| 1 | 96.036 | 3.94 | 1.92286 | 20.9 | |
| 2 | 165.145 | 1.74 | | | |
| 3 | 43.871 | 7.45 | 1.59282 | 68.6 | |
| 4 | 199.452 | 1.20 | | | |
| 5 | 41.105 | 8.58 | 1.57144 | 71.6 | |
| 6 | 205.159 | 1.50 | 1.67300 | 38.3 | 0.5757 |
| 7 | 45.660 | 1.87 | | | |
| 8 | 89.820 | 1.30 | 1.77047 | 29.7 | 0.5951 |
| 9 | 27.064 | 8.04 | | | |
| 10(stop) | ∞ | (variable) | | | |
| 11 | −30.872 | 1.00 | 1.61340 | 44.3 | 0.5633 |
| 12 | 104.842 | 0.60 | | | |
| 13* | 58.317 | 6.67 | 1.80400 | 46.5 | |
| 14* | −70.157 | 0.15 | | | |
| 15 | 104.647 | 1.50 | 1.66565 | 35.6 | 0.5820 |
| 16 | 32.721 | 9.98 | 1.59282 | 68.6 | |
| 17 | −40.480 | (variable) | | | |
| 18 | −610.276 | 1.10 | 1.66565 | 35.6 | |
| 19 | 24.924 | 7.51 | 1.51742 | 52.4 | |
| 20 | 53.590 | 2.74 | | | |
| 21 | 56.249 | 10.87 | 2.00100 | 29.1 | |
| 22 | −40.472 | 1.20 | 1.59270 | 35.3 | 0.5933 |
| 23 | 126.313 | 8.18 | | | |
| 24 | −46.547 | 1.30 | 1.59270 | 35.3 | 0.5933 |
| 25 | −245.357 | 14.15 | | | |
| image plane | ∞ | | | | |

Aspherical data
The thirteenth surface
K = 0.00000e+00 A 4 = −3.26921e−06 A 6 = 1.45128e−09
A 8 = −1.87179e−11 A10 = 8.17637e−14 A12 = −3.63818e−16
The fourteenth surface
K = 0.00000e+00 A 4 = 2.84441e−06 A 6 = 2.38339e−09
A 8 = −1.47714e−11 A10 = 7.16272e−14 A12 = −3.29602e−16

Various data

| | |
|---|---|
| Focal length | 71.96 |
| F-number | 1.49 |
| Half angle of view | 16.73 |
| Image height | 21.63 |
| Total lens length | 120.00 |
| BF | 14.15 |

| | Infinity | Closest distance |
|---|---|---|
| d10 | 15.28 | 7.40 |
| d17 | 2.15 | 10.03 |

Lens unit data

| Unit | Leading surface | Focal length |
|---|---|---|
| 1 | 1 | 259.06 |
| 2 | 11 | 49.49 |
| 3 | 18 | −452.01 |

Numerical embodiment 11]
Unit mm
Surface data

| Surface | | | | | |
|---|---|---|---|---|---|
| number | r | d | nd | vd | θgF |
| 1 | 80.476 | 3.30 | 2.00272 | 19.3 | |
| 2 | 136.737 | 0.42 | | | |
| 3 | 42.622 | 9.98 | 1.53775 | 74.7 | |
| 4 | 188.580 | 2.21 | | | |
| 5 | 61.387 | 2.00 | 1.66565 | 35.6 | 0.5820 |
| 6 | 27.345 | 1.42 | | | |
| 7 | 29.388 | 10.67 | 1.49700 | 81.5 | |
| 8 | −349.827 | 2.00 | 1.90110 | 27.1 | 0.6072 |
| 9 | 51.140 | 8.98 | | | |
| 10(stop) | ∞ | (variable) | | | |
| 11 | −38.926 | 1.18 | 1.62205 | 41.1 | 0.5690 |
| 12 | 106.556 | 0.20 | | | |
| 13 | 63.727 | 4.51 | 1.95375 | 32.3 | |
| 14* | −71.338 | 2.62 | | | |
| 15 | −77.137 | 1.17 | 1.66565 | 35.6 | 0.5820 |
| 16 | 39.878 | 7.69 | 1.65160 | 58.5 | |
| 17 | −38.330 | (variable) | | | |
| 18 | −682.105 | 2.18 | 1.95375 | 32.3 | |
| 19 | −99.194 | 1.17 | 1.75211 | 25.0 | |
| 20 | 65.974 | 6.01 | | | |
| 21 | 56.104 | 7.44 | 2.00100 | 29.1 | |
| 22 | −65.877 | 0.90 | 1.54072 | 47.2 | 0.5651 |
| 23 | 51.489 | 8.92 | | | |
| 24 | −33.649 | 2.69 | 1.51742 | 52.4 | 0.5564 |
| 25 | −63.183 | 12.06 | | | |
| image plane | ∞ | | | | |

Aspherical data
The fourteenth surface
K = 0.00000e+00 A 4 = 5.26742e−06 A 6 = −4.71748e−09
A 8 = 5.30510e−11 A10 = −2.19645e−13 A12 = 3.36431e−16

Various data

| | |
|---|---|
| Focal length | 82.50 |
| F-number | 1.46 |
| Half angle of view | 14.69 |
| Image height | 21.63 |
| Total lens length | 117.80 |
| BF | 12.06 |

| | Infinity | Closest distance |
|---|---|---|
| d10 | 16.07 | 3.60 |
| d17 | 2.00 | 14.47 |

Lens unit data

| Unit | Leading Focal | surface length |
|---|---|---|
| 1 | 1 | 169.04 |
| 2 | 11 | 64.90 |
| 3 | 18 | −449.50 |

[Numerical embodiment 12]
Unit mm
Surface data

| Surface | | | | | |
|---|---|---|---|---|---|
| number | r | d | nd | vd | θgF |
| 1 | 85.221 | 3.86 | 1.79631 | 22.6 | |
| 2 | 159.037 | 0.30 | | | |
| 3 | 43.764 | 9.39 | 1.59282 | 68.6 | |
| 4 | 166.271 | 1.10 | | | |
| 5 | 34.819 | 8.31 | 1.49700 | 81.7 | |
| 6 | 107.467 | 1.50 | 1.77047 | 29.7 | 0.5951 |
| 7 | 39.513 | 1.90 | | | |
| 8 | 55.972 | 1.30 | 1.77047 | 29.7 | 0.5951 |
| 9 | 25.750 | 9.39 | | | |
| 10(stop) | ∞ | (variable) | | | |
| 11 | −30.437 | 1.00 | 1.61340 | 44.3 | 0.5633 |
| 12 | 174.473 | 0.20 | | | |
| 13* | 51.841 | 7.50 | 1.80400 | 46.5 | |
| 14* | −59.960 | 0.15 | | | |
| 15 | 401.421 | 1.00 | 1.61340 | 44.3 | 0.5633 |
| 16 | 25.502 | 8.45 | 1.59282 | 68.6 | |
| 17 | −45.229 | (variable) | | | |
| 18 | −960.535 | 1.10 | 1.72342 | 38.0 | |
| 19 | 25.478 | 4.63 | 1.51742 | 52.4 | |
| 20 | 43.377 | 4.03 | | | |
| 21 | 55.508 | 10.15 | 2.00100 | 29.1 | |
| 22 | −40.068 | 1.20 | 1.59270 | 35.3 | 0.5933 |
| 23 | 92.796 | 7.60 | | | |
| 24 | −46.751 | 1.30 | 1.59270 | 35.3 | 0.5933 |
| 25 | −129.983 | 14.16 | | | |
| image plane | ∞ | | | | |

Aspherical data
The thirteenth surface
K = 0.00000e+00 A 4 = −3.52516e−06 A 6 = 5.21660e−09
A 8 = −8.42824e−12 A10 = 2.96841e−14 A12 = 2.42859e−17
The fourteenth surface
K = 0.00000e+00 A 4 = 3.41076e−06 A 6 = 5.23989e−09
A 8 = −1.34642e−11 A10 = 5.58489e−14 A12 = −5.82497e−18

Various data

| | |
|---|---|
| Focal length | 82.50 |
| F-number | 1.46 |
| Half angle of view | 14.69 |
| Image height | 21.63 |
| Total lens length | 118.00 |
| BF | 14.16 |

| | Infinity | Closest distance |
|---|---|---|
| d10 | 16.49 | 8.28 |
| d17 | 2.00 | 10.21 |

Lens unit data

| Unit | Leading surface | Focal length |
|---|---|---|
| 1 | 1 | 191.96 |
| 2 | 11 | 49.71 |
| 3 | 18 | −181.57 |

[Numerical embodiment 13]
Unit mm
Surface data

| Surface | | | | | |
|---|---|---|---|---|---|
| number | r | d | nd | vd | θgF |
| 1 | 90.873 | 4.75 | 1.84666 | 23.8 | |
| 2 | 144.992 | 0.20 | | | |
| 3 | 42.388 | 9.56 | 1.59522 | 67.7 | |
| 4 | 196.547 | 0.70 | | | |
| 5 | 37.986 | 8.03 | 1.53775 | 74.7 | |
| 6 | 139.935 | 1.50 | 1.62205 | 41.1 | 0.5690 |
| 7 | 48.642 | 1.77 | | | |
| 8 | 80.781 | 1.30 | 1.77047 | 29.7 | 0.5951 |
| 9 | 25.735 | 9.24 | | | |
| 10(stop) | ∞ | (variable) | | | |
| 11 | −32.508 | 1.00 | 1.61340 | 44.3 | 0.5633 |
| 12 | 114.767 | 0.48 | | | |
| 13* | 55.829 | 6.97 | 1.80400 | 46.5 | |
| 14* | −69.035 | 0.15 | | | |
| 15 | 115.905 | 1.05 | 1.62205 | 41.1 | 0.5690 |
| 16 | 27.212 | 10.28 | 1.59522 | 67.7 | |
| 17 | −43.076 | (variable) | | | |
| 18 | −224.752 | 1.10 | 1.72000 | 46.0 | |
| 19 | 25.725 | 5.32 | 1.51633 | 64.1 | |
| 20 | 45.990 | 4.15 | | | |
| 21 | 57.383 | 13.85 | 1.95375 | 32.3 | |
| 22 | −35.435 | 2.00 | 1.59270 | 35.3 | 0.5933 |
| 23 | 116.204 | 10.29 | | | |
| 24 | −39.516 | 1.38 | 1.59270 | 35.3 | 0.5933 |
| 25 | −88.283 | 7.95 | | | |
| image plane | ∞ | | | | |

Aspherical data
The thirteenth surface
K = 0.00000e+00 A 4 = −3.32857e−06 A 6 = 2.05846e−10
A 8 = −2.68855e−11 A10 = 1.54565e−13 A12 = −5.10548e−16
The fourteenth surface
K = 0.00000e+00 A 4 = 3.06068e−06 A 6 = 1.73611e−09
A 8 = −3.11197e−11 A10 = 1.70198e−13 A12 = −5.04008e−16

various data
Various data

| | |
|---|---|
| Focal length | 79.95 |
| F-number | 1.46 |
| Half angle of view | 15.14 |
| Image height | 21.63 |
| Total lens length | 120.00 |
| BF | 7.95 |

| | Infinity | Closest distance |
|---|---|---|
| d10 | 14.82 | 7.53 |
| d17 | 2.15 | 9.44 |

Lens unit data

| Unit | Leading surface | Focal length |
|---|---|---|
| 1 | 1 | 184.57 |
| 2 | 11 | 46.80 |
| 3 | 18 | −137.44 |

[Numerical Embodiment 14]
Unit mm
Surface data

| Surface | | | | | |
|---|---|---|---|---|---|
| number | r | d | nd | vd | θgF |
| 1 | 91.681 | 3.32 | 2.00272 | 19.3 | |
| 2 | 126.718 | 0.20 | | | |
| 3 | 41.875 | 9.47 | 1.59522 | 67.7 | |
| 4 | 210.215 | 0.70 | | | |
| 5 | 39.472 | 8.28 | 1.49700 | 81.7 | |
| 6 | 203.536 | 1.67 | 1.62205 | 41.1 | 0.5690 |
| 7 | 52.590 | 1.72 | | | |
| 8 | 92.811 | 1.30 | 1.77047 | 29.7 | 0.5951 |
| 9 | 26.803 | 8.83 | | | |
| 10(stop) | ∞ | (variable) | | | |
| 11 | −30.189 | 1.00 | 1.61340 | 44.3 | 0.5633 |
| 12 | 93.151 | 0.54 | | | |
| 13* | 52.739 | 7.55 | 1.80400 | 46.5 | |
| 14* | −65.607 | 0.15 | | | |
| 15 | 202.328 | 1.00 | 1.66565 | 35.6 | 0.5820 |
| 16 | 38.038 | 10.00 | 1.61997 | 63.9 | |
| 17 | −39.980 | (variable) | | | |
| 18 | −311.870 | 1.10 | 1.69600 | 36.3 | |
| 19 | 26.088 | 5.24 | 1.49700 | 81.7 | |
| 20 | 46.928 | 2.11 | | | |
| 21 | 54.202 | 10.04 | 2.00100 | 29.1 | |
| 22 | −38.703 | 1.20 | 1.59270 | 35.3 | 0.5933 |
| 23 | 355.913 | 2.97 | | | |
| 24 | −69.982 | 1.20 | 1.59270 | 35.3 | 0.5933 |
| 25 | 227.201 | 23.37 | | | |
| image plane | ∞ | | | | |

Aspherical Data
The thirteenth surface
K = 0.00000e+00 A 4 = −4.21523e−06 A 6 = 1.54639e−09
A 8 = −3.77992e−11 A10 = 1.96151e−13 A12 = −5.60818e−16
The fourteenth surface
K = 0.00000e+00 A 4 = 3.26258e−06 A 6 = 1.70302e−09
A 8 = −2.79184e−11 A10 = 1.51825e−13 A12 = −4.57870e−16

Various Data

| | |
|---|---|
| Focal length | 77.89 |
| F number | 1.46 |
| Half field angle | 15.52 |
| Image height | 21.63 |
| Lens length | 120.30 |
| BF | 23.37 |

| | Infinity | Closest distance |
|---|---|---|
| d10 | 15.33 | 7.43 |
| d17 | 2.00 | 9.90 |

Lens unit data

| Unit | Leading surface | Focal length |
|---|---|---|
| 1 | 1 | 221.91 |
| 2 | 11 | 49.24 |
| 3 | 18 | −346.41 |

The numerical values corresponding to the inequalities (1) to (35) in each embodiment are shown in Tables 1 and 2 below.

TABLE 1
Numerical values corresponding to the inequalities in embodiments 1-7

| | | Numerical Embodiment | | | | | | |
|---|---|---|---|---|---|---|---|---|
| Ine quality | | 1 | 2 | 3 | 4 | 5 | 6 | 7 |
| (1) | (L1n1) | 1.770 | 1.770 | 1.770 | 1.770 | 1.770 | 1.666 | 1.673 |
| | (L1n2) | 1.770 | 1.730 | 1.770 | 1.730 | 1.770 | 1.770 | 1.770 |
| (2) | (L1n1) | 2.217 | 2.217 | 2.217 | 2.217 | 2.217 | 2.200 | 2.247 |
| | (L1n2) | 2.217 | 2.214 | 2.217 | 2.214 | 2.217 | 2.217 | 2.217 |
| (3) | (L1n1) | 29.736 | 29.736 | 29.736 | 29.736 | 29.736 | 35.640 | 38.260 |
| | (L1n2) | 29.736 | 32.233 | 29.736 | 32.233 | 29.736 | 29.736 | 29.736 |
| (4) | (L1n1) | −0.0087 | −0.0087 | −0.0087 | −0.0087 | −0.0087 | −0.0064 | −0.0065 |
| | (L1n2) | −0.0087 | −0.0071 | −0.0087 | −0.0071 | −0.0087 | −0.0087 | −0.0087 |
| (5) | | 0.180 | 0.181 | 0.145 | 0.145 | 0.183 | 0.179 | 0.151 |
| (6) | | 2.375 | 2.393 | 2.331 | 2.030 | 2.294 | 2.031 | 1.741 |
| (7) | | 0.627 | 0.641 | 0.800 | 0.757 | 0.604 | 0.503 | 0.491 |
| (8) | | −0.395 | −0.331 | 0.080 | −0.098 | −0.404 | −0.734 | −0.734 |
| (9) | | 0.264 | 0.268 | 0.343 | 0.373 | 0.263 | 0.248 | 0.282 |
| (10) | | −0.248 | −0.212 | 0.064 | −0.074 | −0.244 | −0.369 | −0.360 |
| (11) | | 1.808 | 1.847 | 2.001 | 2.001 | 1.847 | 1.808 | 1.904 |
| (12) | | 22.760 | 23.870 | 25.458 | 25.458 | 23.870 | 22.760 | 31.315 |
| (13) | | 0.469 | 0.503 | 0.640 | 1.009 | 0.480 | 0.308 | 0.406 |
| (14) | | 0.951 | 0.945 | 1.664 | 1.186 | 1.185 | 1.622 | 1.512 |
| (15) | | 34.460 | 52.430 | 22.760 | 28.460 | 35.310 | 35.310 | 35.310 |
| (16) | | 0.0009 | 0.0020 | 0.0061 | 0.0003 | 0.0041 | 0.0041 | 0.0041 |
| (17) | | 48.840 | 38.030 | 58.900 | 52.430 | 35.310 | 35.310 | 35.310 |
| (18) | | 0.0026 | 0.0008 | 0.0009 | 0.0020 | 0.0041 | 0.0041 | 0.0041 |
| (19) | | 0.304 | 0.294 | 0.297 | 0.305 | 0.309 | 0.300 | 0.269 |
| (20) | | 5.462 | 6.057 | 7.851 | 5.207 | 5.748 | 3.004 | 4.441 |
| (21) | | 29.736 | 30.985 | 29.736 | 30.985 | 29.736 | 32.688 | 33.998 |
| (22) | | 1.000 | 0.977 | 1.000 | 0.977 | 1.000 | 1.063 | 1.058 |
| (23) | | −0.115 | −0.119 | −0.168 | −0.163 | −0.102 | 0.076 | −0.101 |
| (24) | | −0.358 | −0.306 | 0.093 | −0.108 | −0.356 | 0.538 | −0.525 |
| (25) | (L2n1) | −0.0059 | −0.0059 | −0.0059 | −0.0059 | −0.0058 | −0.0058 | −0.0058 |
| | (L2n2) | −0.0052 | −0.0059 | −0.0087 | −0.0071 | −0.0058 | −0.0069 | −0.0064 |

| | | | | | | | |
|---|---|---|---|---|---|---|---|
| (26) | 0.386 | 0.390 | 0.461 | 0.501 | 0.377 | 0.369 | 0.449 |
| (27) | 1.090 | 1.072 | 0.931 | 0.983 | 1.157 | 1.333 | 1.281 |
| (28) | 1.010 | 0.974 | 0.683 | 0.724 | 1.150 | 1.535 | 1.310 |
| (29) | 13.157 | 13.245 | 16.029 | 13.962 | 12.539 | 11.330 | 11.507 |
| (30) | 3.474 | 3.548 | 5.498 | 5.203 | 3.302 | 2.807 | 3.247 |
| (31) | −0.071 | −0.060 | 0.012 | −0.014 | −0.074 | −0.132 | −0.111 |
| (32) | 0.268 | 0.280 | 0.276 | 0.301 | 0.303 | 0.288 | 0.277 |
| (33) | 2.375 | 2.393 | 2.331 | 2.030 | 2.294 | 2.031 | 1.741 |
| (34) | 0.763 | 0.754 | 0.725 | 0.772 | 0.783 | 0.820 | 0.793 |
| (35) | 0.321 | 0.315 | 0.311 | 0.380 | 0.341 | 0.404 | 0.456 |

TABLE 2
Numerical values corresponding to the inequalities in embodiments 8-14

| | | Numerical Embodiment | | | | | | |
|---|---|---|---|---|---|---|---|---|
| Inequality | | 8 | 9 | 10 | 11 | 12 | 13 | 14 |
| (1) | (11n1) | 1.666 | 1.730 | 1.673 | 1.666 | 1.770 | 1.622 | 1.622 |
| | (11n2) | 1.770 | 1.770 | 1.770 | 1.901 | 1.770 | 1.770 | 1.770 |
| (2) | (11n1) | 2.200 | 2.214 | 2.247 | 2.200 | 2.217 | 2.238 | 2.238 |
| | (11n2) | 2.217 | 2.217 | 2.217 | 2.307 | 2.217 | 2.217 | 2.217 |
| (3) | (11n1) | 35.640 | 32.233 | 38.260 | 35.640 | 29.736 | 41.080 | 41.080 |
| | (11n2) | 29.736 | 29.736 | 29.736 | 27.058 | 29.736 | 29.736 | 29.736 |
| (4) | (11n1) | −0.0064 | −0.0071 | −0.0065 | −0.0064 | −0.0087 | −0.0069 | −0.0069 |
| | (11n2) | −0.0087 | −0.0087 | −0.0087 | −0.0042 | −0.0087 | −0.0087 | −0.0087 |
| (5) | | 0.179 | 0.163 | 0.197 | 0.146 | 0.172 | 0.099 | 0.300 |
| (6) | | 2.115 | 2.121 | 3.600 | 2.049 | 2.327 | 2.308 | 2.849 |
| (7) | | 0.533 | 0.909 | 0.688 | 0.787 | 0.603 | 0.585 | 0.632 |
| (8) | | −0.642 | 0.000 | −0.159 | −0.184 | −0.454 | −0.582 | −0.225 |
| (9) | | 0.252 | 0.429 | 0.191 | 0.384 | 0.259 | 0.254 | 0.222 |
| (10) | | −0.342 | 0.000 | −0.109 | −0.144 | −0.274 | −0.341 | −0.142 |
| (11) | | 1.847 | 1.923 | 1.923 | 2.003 | 1.796 | 1.847 | 2.003 |
| (12) | | 23.870 | 20.881 | 20.881 | 19.317 | 22.610 | 23.780 | 19.317 |
| (13) | | 0.322 | 0.808 | 0.385 | 0.528 | 0.432 | 0.321 | 0.273 |
| (14) | | 1.376 | 1.569 | 1.142 | 1.119 | 1.099 | 1.474 | 1.294 |
| (15) | | 35.310 | 35.310 | 35.310 | 52.430 | 35.310 | 35.310 | 35.310 |
| (16) | | 0.0041 | 0.0041 | 0.0041 | 0.0020 | 0.0041 | 0.0041 | 0.0041 |
| (17) | | 35.310 | 35.310 | 35.310 | 47.230 | 35.310 | 35.310 | 35.310 |
| (18) | | 0.0041 | 0.0041 | 0.0041 | 0.0016 | 0.0041 | 0.0041 | 0.0041 |
| (19) | | 0.300 | 0.316 | 0.346 | 0.331 | 0.309 | 0.322 | 0.335 |
| (20) | | 4.220 | 5.555 | 6.564 | 7.251 | 5.416 | 4.467 | 5.544 |
| (21) | | 32.688 | 30.985 | 33.998 | 31.349 | 29.736 | 35.408 | 35.408 |
| (22) | | 1.063 | 1.023 | 1.058 | 1.141 | 1.000 | 1.092 | 1.092 |
| (23) | | −0.084 | −0.161 | −0.109 | −0.151 | −0.099 | −0.091 | −0.101 |
| (24) | | 0.498 | 0.000 | −0.159 | −0.210 | −0.399 | −0.496 | 0.207 |
| (25) | (L2n1) | −0.0058 | −0.0059 | −0.0059 | −0.0069 | −0.0058 | −0.0058 | −0.0058 |
| | (L2n2) | −0.0064 | −0.0071 | −0.0064 | −0.0064 | −0.0058 | −0.0069 | −0.0064 |

| | | | | | | | |
|---|---|---|---|---|---|---|---|
| (26) | 0.371 | 0.490 | 0.270 | 0.474 | 0.367 | 0.360 | 0.314 |
| (27) | 1.274 | 0.962 | 1.030 | 1.030 | 1.172 | 1.204 | 1.118 |
| (28) | 1.398 | 0.704 | 0.983 | 0.822 | 1.188 | 1.262 | 1.127 |
| (29) | 11.795 | 13.018 | 18.310 | 14.013 | 13.559 | 23.224 | 9.496 |
| (30) | 2.971 | 5.581 | 3.498 | 5.380 | 3.511 | 5.889 | 2.107 |
| (31) | −0.115 | 0.000 | −0.031 | −0.027 | −0.078 | −0.058 | −0.067 |
| (32) | 0.281 | 0.309 | 0.324 | 0.304 | 0.314 | 0.301 | 0.310 |
| (33) | 2.115 | 2.121 | 3.600 | 2.049 | 2.327 | 2.308 | 2.849 |
| (34) | 0.809 | 0.875 | 0.730 | 0.871 | 0.800 | 0.827 | 0.744 |
| (35) | 0.383 | 0.413 | 0.203 | 0.425 | 0.344 | 0.358 | 0.261 |

### [Image Pickup Apparatus]

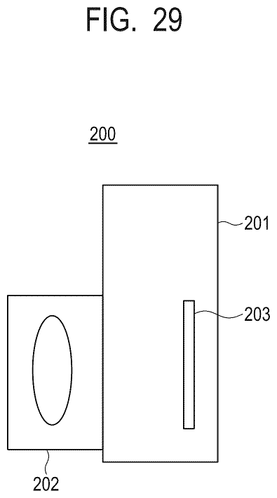

Next, an embodiment of a digital still camera (image pickup apparatus) 200 using the lens apparatus of the disclosure will be described with reference to FIG. 29. In FIG. 29, reference numeral 201 denotes a camera body, and 202 denotes any of the lens apparatuses described in the first to fourteenth embodiments.

Reference numeral 203 denotes a solid-state image pickup element (photoelectric conversion element) such as a CCD sensor or a CMOS sensor which is built in the camera body and receives and photoelectrically converts an optical image formed by the lens apparatus 202. An optical member having no power, such as an optical low-pass filter or an ND filter, may be disposed in front of the solid-state image pickup element. The camera main body 201 may be a so-called single-lens reflex camera having a quick return mirror or may be a so-called mirrorless camera having no quick return mirror.

As described above, by applying the lens apparatus 202 of the disclosure to an image pickup apparatus such as a digital still camera, it is possible to provide an image pickup apparatus that is small in size and can satisfactorily correct chromatic aberration and curvature of field in an image pickup apparatus including a large-aperture intermediate telephoto lens apparatus.

Although preferred embodiments of the disclosure have been described above, the disclosure is not limited to these embodiments, and various combinations, modifications, and changes are possible within the scope of the gist thereof.

According to the disclosure, it is possible to provide a small-sized lens apparatus having a large aperture and a middle telephoto capable of satisfactorily correcting chromatic aberration and curvature of field.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-208503, filed Nov. 29, 2024, which is hereby incorporated by reference herein in its entirety.

What is claimed is:

1. A lens apparatus comprising in order from an object side to an image side:
a first lens unit having a positive refractive power; a second lens unit having a positive refractive power; and a third lens unit, wherein an interval between adjacent lens units is changed during focusing,
wherein the second lens unit is moved during focusing,
wherein the first lens unit includes, in order from the object side to the image side, two meniscus positive lenses each having a convex surface on the object side arranged consecutively,
wherein the first lens unit includes a first negative lens having a negative refractive power,
wherein the following inequalities are satisfied,
$$1.5 < ndb 1 n < 2 \text{.35} - 0.015 \times vdb 1 n$$
$$26. < vdb 1 n < 60.$$
$$- 0.1 \; 00 < θ gFb 1 n - ( - 9.529 \times 1 {0}^{- 8} \times vdb 1 {n}^{3} + 3.694 \times 1 {0}^{- 5} \times vdb 1 {n}^{2} - 4.717 \times 1 {0}^{- 3} \times vdb 1 n + 7.139 \times 1 {0}^{- 1} ) < 0.0 \; 00$$
$$0.03 < Bf / f < 0.4$$
where ndb1n represents a refractive index of the first negative lens for d-line, vdb1n represents an Abbe number of the first negative lens for d-line, θgFb1n represents a partial dispersion ratio of the first negative lens with respect to the g-line, Bf represents a distance on an optical axis from a lens surface closest to the image side to an image plane, and f represents a focal length of the lens apparatus in the infinity focus state.

2. The lens apparatus according to claim 1, wherein the following inequality is satisfied,
$$1. < f 1 / f < 5.$$
where f1 represents a focal length of the first lens unit.

3. The lens apparatus according to claim 1, wherein the following inequality is satisfied,
$$0.3 < f 2 / f < 1.5$$
where f2 represents a focal length of the second lens unit.

4. The lens apparatus according to claim 1, wherein the following inequality is satisfied,
$$- 2.00 < f / f 3 < 1.$$
where f3 represents a focal length of the third lens unit.

5. The lens apparatus according to claim 1, wherein the following inequality is satisfied,
$$0.10 < f 2 / f 1 < 0.7$$
where f1 represents a focal length of the first lens unit and f2 represents a focal length of the second lens unit.

6. The lens apparatus according to claim 1, wherein the following inequality is satisfied,
$$- 1. < f 2 / f 3 < 0.50$$
where f2 represents a focal length of the second lens unit and f3 represents a focal length of the third lens unit.

7. The lens apparatus according to claim 1, wherein the following inequality is satisfied,
$$1. 60 < nd 1 < 2.5$$
$$13. 0 < vd 1 < 50.$$
where nd1 represents a refractive index with respect to d-line and vd1 represents an Abbe number with respect to d-line of the lens disposed closest to the object side in the first lens unit.

8. The lens apparatus according to claim 1, wherein the following inequality is satisfied,
$$0.15 < fg 2 / fg 1 < 1.5$$
where fg1 represents a focal length of a lens disposed closest to the object side in the first lens unit and fg2 represents a focal length of a lens disposed second closest to the object side in the first lens unit.

9. The lens apparatus according to claim 1, wherein the following inequality is satisfied,
$$0.5 < ( b 3 F R + b 2 L R ) / ( b 3 F R - b 2 L R ) < 2.50$$
where b2LR represents a curvature radius of a lens surface closest to the image side in the second lens unit, and b3FR represents a curvature radius of a lens surface closest to the object side in the third lens unit.

10. The lens apparatus according to claim 1, wherein the first lens unit includes a lens disposed third from the object side which is a meniscus lens having a convex surface on the object side.

11. The lens apparatus according to claim 1, wherein the first lens unit includes a lens disposed fourth from the object side which is a meniscus lens having a convex surface on the object side.

12. The lens apparatus according to claim 1, wherein the first lens unit includes a lens disposed fifth from the object side which is a meniscus lens having a convex surface on the object side.

13. The lens apparatus according to claim 1, wherein the following inequality is satisfied,
$$0.2 < \vert R min \vert / f < 0.6$$
where |Rmin| represents a radius of curvature having the smallest absolute value in optical surfaces included in the first lens unit and the third lens unit.

14. The lens apparatus according to claim 1, wherein the following inequality is satisfied,
$$0.9 < ndgn 2 / ndgn 1 < 1.3$$
where ndgn1 represents a refractive index of one of negative lenses disposed in the first lens unit and ndgn2 represents a refractive index of a negative lens disposed on the image side of the one of negative lenses.

15. The lens apparatus according to claim 1, wherein the second lens unit includes at least three lenses.

16. The lens apparatus according to claim 1, wherein the following inequality is satisfied,
$$- 0.30 < M 2 / f < - 0.03$$
where M2 represents a relative movement amount of the second lens unit with respect to an image plane during focusing from infinity to closest distance where a sign of a direction of movement from the object side to the image side is positive.

17. The lens apparatus according to claim 1, wherein a lens disposed closest to the object side in the second lens unit has a negative refractive power.

18. The lens apparatus according to claim 1, wherein the following inequality is satisfied,
$$5. 00 < f 1 / Bf < 30.00$$
where f1 represents a focal length of the first lens unit.

19. The lens apparatus according to claim 1, wherein the following inequality is satisfied,
$$1. 00 < f 2 / B f < 10.00$$
where f2 represents a focal length of the second lens unit.

20. The lens apparatus according to claim 1, wherein the following inequality is satisfied,
$$- 0.30 < B f / f 3 < 0.10$$
where f3 represents a focal length of the third lens unit.

21. The lens apparatus according to claim 1, wherein the following inequality is satisfied,
$$1. 00 < f 1 / f < 4.50$$
where f1 represents a focal length of the first lens unit.

22. The lens apparatus according to claim 1, wherein the number of lens unit is three in total.

23. An image pickup apparatus, comprising a lens apparatus, and an image pickup element configured to pick up an image formed by the lens apparatus,
wherein the lens apparatus includes in order from an object side to an image side: a first lens unit having a positive refractive power; a second lens unit having a positive refractive power; and a third lens unit, wherein an interval between adjacent lens units is changed during focusing,
wherein the second lens unit is moved during focusing,
wherein the first lens unit includes, in order from the object side to the image side, two meniscus positive lenses each having a convex surface on the object side arranged consecutively,
wherein the first lens unit includes a first negative lens having a negative refractive power,
wherein the following inequalities are satisfied,
$$1.5 < ndb 1 n < 2 \text{.35} - 0.015 \times vdb 1 n$$
$$26. < vdb 1 n < 60.$$
$$- 0.1 \; 00 < θ gF b 1 n - ( - 9.529 \times 1 {0}^{- 8} \times vdb 1 {n}^{3} + 3.694 \times 1 {0}^{- 5} \times vdb 1 {n}^{2} - 4.717 \times 1 {0}^{- 3} \times vdb 1 n + 7.139 \times 1 {0}^{- 1} ) < 0.0 \; 00$$
$$0.03 < Bf / f < 0.4$$
where ndb1n represents a refractive index of the first negative lens for d-line, vdb1n represents an Abbe number of the first negative lens for d-line, θgFb1n represents a partial dispersion ratio of the first negative lens with respect to the g-line, Bf represents a distance on an optical axis from a lens surface closest to the image side to an image plane, and f represents a focal length of the lens apparatus in the infinity focus state.
